(19) United States
(12) Patent Application Publication
(10) Pub. No.: US 2025/0387748 A1
(43) Pub. Date: Dec. 25, 2025

(54) SYSTEMS AND PROCESS FOR CARBON CAPTURE AND CONVERSION

(71) Applicant: THE BOARD OF TRUSTEES OF THE UNIVERSITY OF ILLINOIS, Urbana, IL (US)

(72) Inventors: Meenesh R. Singh, Naperville, IL (US); Aditya Prajapati, Chicago, IL (US); Rohan Sartape, Chicago, IL (US)

(21) Appl. No.: 19/255,070

(22) Filed: Jun. 30, 2025

Related U.S. Application Data
(62) Division of application No. 18/016,218, filed on Jan. 13, 2023, now Pat. No. 12,350,622.
(60) Provisional application No. 63/051,785, filed on Jul. 14, 2020.
(60) Provisional application No. 63/210,865, filed on Jun. 15, 2021.

(51) Int. Cl. B01D 53/14; B01D 53/22; B01D 53/62; B01D 53/78; B01D 53/86; B01D 71/28; C25B 1/04; C25B 1/23; C25B 3/03; C25B 3/07; C25B 3/26; C25B 9/19; C25B 9/70; C25B 11/03; C25B 11/052; C25B 11/075

(52) U.S. Cl. CPC B01D 53/1475; B01D 53/1493; B01D 53/229; B01D 53/62; B01D 53/78; B01D 53/8671; B01D 71/281; C25B 1/04; C25B 1/23; C25B 3/03; C25B 3/07; C25B 3/26; C25B 9/19; C25B 9/70; C25B 11/03; C25B 11/052; C25B 11/075; B01D 2053/224; B01D 2251/604; B01D 2252/30; B01D 2255/20761; B01D 2257/504; B01D 2258/0283; B01D 2258/06

(57) ABSTRACT

An active CO₂ capture unit for capturing CO₂ from a dilute source of CO₂ input gas can include an inlet through which an input gas is introduced into the unit and a non-aqueous region comprising a non-aqueous CO₂ binding organic liquid containing OH⁻ arranged to be in contact with the input gas to chemisorb CO₂ from the input gas and convert the chemisorbed CO₂ into HCO₃⁻ by reacting with OH⁻. The unit also includes an aqueous region arranged downstream of the non-aqueous region, wherein at an aqueous region interface, the HCO₃⁻ interacts with H₂O and decomposes to CO₂ and CO₃². An anion exchange membrane is disposed between the non-aqueous region and the aqueous region to facilitate HCO₃⁻ diffusion and migration from the non-aqueous region to the aqueous region. A captured CO₂ outlet is disposed downstream of the aqueous region.

### CROSS REFERENCE TO RELATED APPLCIATIONS

This application is Divisional of U.S. application Ser. No. 18/016,218 filed Jan. 13, 2023, which in turn is a U.S. National phase of International Patent Application No. PCT/US2021/041677 filed Jul. 14, 2021, which claims the priority benefit of U.S. Provisional Application 63/210,865 filed on Jun. 15, 2021, and U.S. Provisional Application 63/051,785 filed on Jul. 14, 2020, the respective disclosures of which are hereby incorporated by reference in their entireties.

### BACKGROUND

### Field of the Disclosure

The disclosure relates to systems and processes for capture and conversion of CO₂, and more particularly for capture and conversion of CO₂ from sources like power plants and chemical industries and even from the air generally, which can advantageously reduce the anthropogenic carbon footprint.

### Brief Description of Related Technology

Currently, about 85% of the world energy consumption is supplied from burning fossil fuels, such as petroleum, natural gas, and coal. Despite the low cost and high energy density of fossil fuels, the use of fossil fuels is unavoidably coupled to the release of many undesirable compounds, such as carbon dioxide (CO₂), which can cause a number of adverse effects on the environment, including ocean acidification, climate change and the like.

Conventional CO₂ capture technologies include absorption, cryogenic distillation, adsorption, and membrane separation. Liquid absorbents such as monoethanolamine (MEA), diethanolamine, and aqueous hydroxide solutions are widely employed in industry to capture CO₂ selectively. The amine-based processes suffer from solvent losses due to evaporation and high viscosity upon CO₂ absorption. The strong binding of CO₂ with the amine functionality necessitates high temperatures, which negatively impacts the energy efficiency of the process. In the case of aqueous hydroxide solutions, the conversion of HCO₃⁻ to CO₃² limits the CO₂ capture capacity and results in high energy consumption for releasing CO₂. Another concern is water loss during the causticization-calcination process for regenerating Ca(OH)₂ for the hydroxide-based approaches. Cryogenic distillation is another established technology that cools CO₂ to below sublimation temperatures (−100 to −135° C.) to separate it from lighter gasses. The temperature requirements of this process make it a highly energy-intensive process. Solid adsorbents like metal-organic frameworks (MOFs), CaO, and alkali metal carbonates exhibit>85% adsorption efficiency and operate as a membrane that separates the CO₂ from a mixture of gasses in the feed either by size exclusion or by relative electrostatic attraction in a single-pass operation. All present CO₂ capture technologies require regeneration of the CO₂ capture medium, which not only makes the process energy-intensive but also discontinuous as no CO₂ is captured during this regeneration step. Process modifications like chemical looping and the use of dual fluidized bed adsorbers have attempted to circumvent this challenge but only at the expense of higher energy consumption.

It has been predicted that over the coming few decades (2010-2060), the cumulative amount of atmospheric CO₂ will increase, up to approximately 496 gigatons, due to fossil fuel combustion in the existing infrastructure. Thus, there is an urgent need for both alternative energy sources and improved control of the rate of CO₂ emissions. However, due to high global energy demands, there is no immediate alternative to replace or substantially reduce production of fossil fuels. The problem is further exacerbated by the low cost of fossil fuels. Fortunately, research into the electrocatalytic reduction of CO₂ has produced a remarkable number of advances over the past few years, yet there is still no known solution that can harvest CO₂ directly from the air and other point sources and convert collected CO₂ emissions into value-added chemicals.

### SUMMARY

Water-driven CO₂ capture techniques are attractive for their low energy penalty. Hydrate-based CO₂ separation is a water-driven technology where CO₂ forms hydrates with water or water-miscible solvents under high pressure and can be separated from a feed with a mixture of gasses. Moisture swing technologies capture CO₂ directly from the air where a quaternary amine ion-exchange resin supported on a polymeric backbone acting as an anion-exchange membrane absorbs CO₂ in a water-deprived (dry) environment in the form of bicarbonates and carbonates, and releases it at CO₂ in a wet environment by virtue of the carbonate-bicarbonate equilibrium. This mechanism can be exploited by keeping a constant water-deprived environment on one side of the anion-exchange membrane with a constant supply of CO₂ and a wet environment on the other side, thereby establishing a gradient of concentration of water across the anion-exchange membrane.

Disclosed herein is an active CO₂ capture unit that utilize a CO₂ binding organic liquid present in a non-aqueous region of the unit to chemisorb CO₂ from an input gas and convert it to HCO₃⁻. The unit includes an anion exchange membrane arranged at an interface between the non-aqueous region and an aqueous region to facilitate transfer of the HCO₃⁻ to the aqueous region where the HCO₃⁻ interacts with H₂O and is decomposed to CO₂ and CO₃².

Also disclosed herein is a system for CO₂ capture and conversion of the captured CO₂ into one or more of C₃H₆, CH₄, C₂H₄, C₂H₅OH, CH₃OH, CO, H₂ and CH₃COOH. Byproducts of the system can include syngas (CO and H₂) and O₂. Systems of the disclosure can be fully integrated systems that combine CO₂ capture and conversion into a single process. The process can be sustainable and energy-efficient.

In accordance with the principles of the present disclosure an automated and fully integrated electrochemical system that combines CO₂ capture and conversion into a single, sustainable and energy-efficient process that can capture CO₂ emissions from ambient air and other point sources and convert the emissions to produce syngas (CO and H₂) with tunable compositions at ambient conditions. Syngas can be used as a feedstock for long-chain hydrocarbon production, such as via Fischer-Tropsch process or the like.

Exemplary embodiments including an integrated electrocatalytic membrane configured for efficient capturing of CO₂ from one or more dilute sources and/or gases at ambient conditions to form a product are set forth. Membranes can be constructed such that supported ionic liquid(s) can include one or more imidazole-based liquids, phosphonium-based liquids, or an anion-exchange membrane or resin. The product can be further defined by at least one of C₂H₄, C₂H₅OH, C₃H₆, CO, H₂, CH₃OH, and CH₃COOH. In certain exemplary embodiments, capture and conversion of CO₂ in the membrane can both occur within the integrated electrocatalytic membrane system. The one or more dilute sources/gases can include flue gas.

### BRIEF DESCRIPTION OF THE DRAWINGS

FIG. 1 is a schematic illustration of a mechanism of CO₂ capture and transport using a moisture-gradient process in accordance with the disclosure.

FIG. 2 is a schematic illustration of a CO₂ capture unit in accordance with the disclosure.

FIG. 3 is a schematic illustration of a system for CO₂ capture and reduction in accordance with the disclosure.

FIG. 4 is a schematic illustration of a system for CO₂ capture and reduction in accordance with the disclosure, with the inset showing a hollow-fiber membrane module based anion exchange membrane.

FIG. 5A is a schematic illustration of a reduction unit having Cu mesh catalyst in accordance with the disclosure.

FIG. 5B is a schematic illustration of a reduction unit having a stack of Cu mesh catalyst in accordance with the disclosure.

FIG. 5C is a scanning electron microscopy image of a Cu mesh catalyst.

FIG. 5D is a graph illustrating the implementation of an oscillating square wave potential amplitude 2V varying from −1.4 V to 0.6 V verse RHE (inset) showing the Faradaic efficiency of ethylene at different frequency (switching time) of the oscillating square wave potential.

FIG. 6 is a schematic illustration of a system for capture and conversion of CO₂ in accordance with the disclosure.

FIG. 7A is a graph of H₂O and HCO₃⁻ counter-diffusion profiles for a multi-physics simulation of direct CO₂ capture from the air using a moisture-gradient process.

FIG. 7B is a graph of the CO₂ and pH profiles of the multi-physics simulation of direct CO₂ capture from the air using a moisture-gradient process.

FIG. 7C is a graph showing the performance curve relationship between CO₂ separation and capture efficiencies of an Excellion anion exchange membrane for the multi-physics simulation of direct CO₂ capture from the air using a moisture-gradient process.

FIG. 7D is a graph showing experimentally measured pH change in 0.3 KOH electrolyte when air is directly sparged (solid) compared to when Excellion (dashed) is used as a contactor. The change in pH is related to CO₂ capture.

FIG. 8 is a schematic illustration of a system in accordance with the disclosure.

FIG. 9 is a graph of separation efficiency as a function of capture efficiency for a capture unit of the disclosure.

FIG. 10A is FTIR spectra of pure CH₃OH (MeOH), NaOH dissolved in MeOH, CO₂ sparged NaOH+MeOH solution, and CO₂ sparged NaOH+MeOH solution with added H₂O. The HCO₃⁻ stretch is dominant in CO₂ sparged NaOH+MeOH solution, which decreases along with increase in CO₃²-stretch with increasing H₂O.

FIG. 10B log(K) increases rapidly with increasing H₂O and reaches a plateau corresponding to the bulk pKa of −3.87 for aqueous HCO₃⁻ solution.

FIG. 11A is a calibration curve showing nearly linear dependence of solution resistance on concentration of HCO₃⁻.

FIG. 11B is a graph showing total moles of CO₂ captured in a solution of 1.2M KOH in ethylene glycol. The average CO₂ capture rate is ˜8.3 μmol/s.

FIG. 12 is a graph of resistance as a function of time, showing that the higher the concentration of the CO₂ in the input gas, the less time required to completely saturate with bicarbonate ions.

FIG. 13 is a graph showing the dynamic increase in the concentration of HCO₃⁻, dissolved and gaseous CO₂ due to migration of HCO₃ ⁻ from organic solution.

FIG. 14 is a graph of pH as a function of time showing the amount of CO₂ migrated with time as observed by a drop in pH.

FIG. 15A is a graph of pH as a function of time showing the effect of the integration of both capture and reduction processes on the migration process.

FIG. 15B is a graph of pH as a function of time showing the effect of humidity on the migration process.

FIG. 16 is a graph showing FE halide percentate as a function of applied potential for different catalysts in a system of the disclosure.

FIG. 17A is a graph showing total current for a #40 mesh Cu catalyst, a #100 mess Cu catalyst and a foam Cu catalyst.

FIG. 17B is a graph showing ethylene partial current for a #40 mesh Cu catalyst, a #100 mess Cu catalyst and a foam Cu catalyst.

FIG. 18 is a graph showing current densiyt as a function of Cu mesh.

FIG. 19 is a graph showing ethylene partial current as a function of Cu mesh.

FIG. 20A is a graph showing oscillating wave of sine and square types.

FIG. 20B is a graph showing ethylene FE percentage as a function of amplitude of the oscillating wave.

FIG. 20C is a graph showing FE percentage as a function of amplitude of the oscillating wave.

FIG. 21 is an experimental set-up to evaluate carbon capture efficiency of an anionic exchange membrane in the presence of moisture gradients.

### DETAILED DESCRIPTION

A moisture-gradient process for CO₂ capture and units for performing such process are disclosed herein. Further, processes for capture and reduction of CO₂ into a desired product and systems for performing the same are also disclosed herein. Such systems can be integrated systems for performing both the capture and reduction processes. Capture units of the disclosure can advantageously capture CO₂ from dilute sources, such as flue gas, other industrial gases, and air, and release substantially pure CO₂. In systems of the disclosure, the released CO₂ can be reduced with by-products produced during the process being recycled into the process to allow for a continuous or substantially continuous process. Intermittent processes for capture and reduction are also contemplated herein.

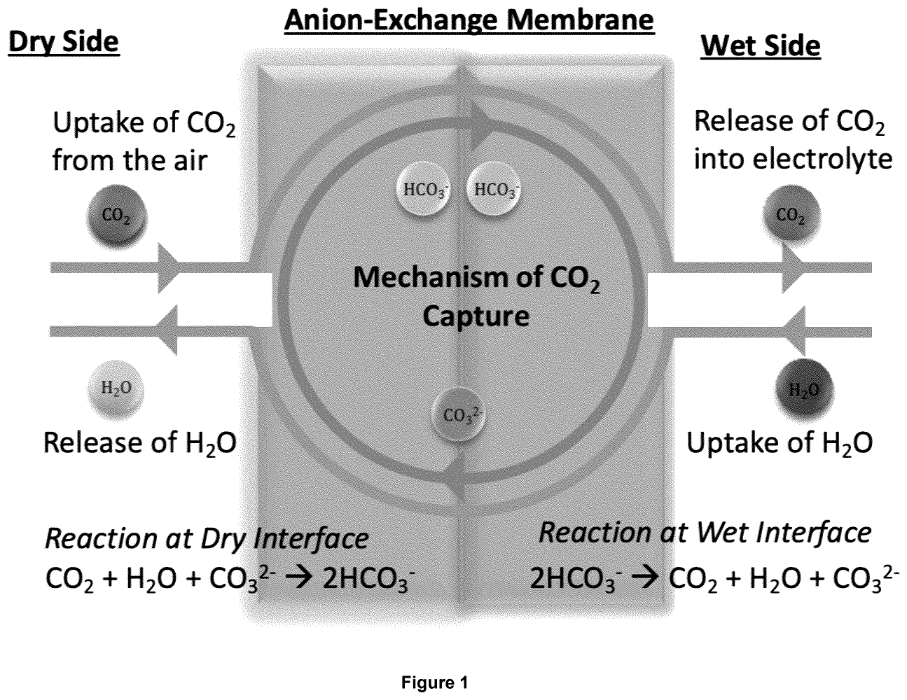

Referring to FIG. 1, CO₂ capture processes of the disclosure can be driven by the reaction

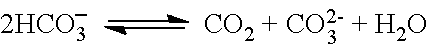

where H₂O autocatalyze this reaction. Without intending to be bound by theory, it is believed that the reaction mechanism represents the autocatalytic HCO₃⁻ decomposition:

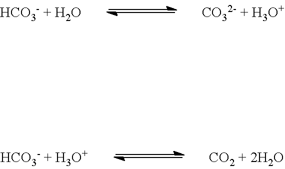

According to Le Chatelier's principle, increasing the concentration of HCO₃⁻ in the membrane will increase the concentration of CO₂ at the aqueous interface (wet-interface), where relative humidity (RH) of water is maintained at 100%. The higher concentration of HCO₃⁻ in the membrane is obtained by reducing the H₂O concentration at the non-aqueous (dry) interface, such that the H₂O bridging the CO₂ and CO₃²⁻ molecules at the dry interface can split to yield two molecules of HCO₃⁻.

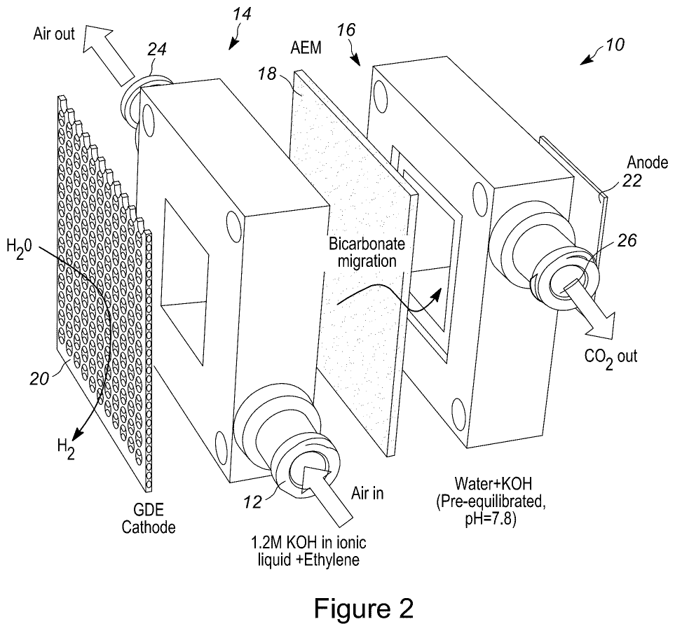

Referring to FIG. 2, active CO₂ capture devices 10 of the disclosure can include an input gas inlet 12, which introduces the input gas into a non-aqueous region 14 of the capture unit 10 for capture of CO₂ from the input gas. The capture unit further includes an aqueous region 16 downstream of the non-aqueous region 14, with an anion exchange membrane 18 disposed between the aqueous 16 and non-aqueous regions 14, such that a gradient of moisture is generated across the anion exchange membrane 18. The unit 10 can alternatively operate as a membrane-electrode unit in which a cathode 20 is provided in the non-aqueous region 14 for decomposition of H₂O to provide a source of OH⁻ to the non-aqueous region 14. In such a unit, H₂O from the aqueous region is reduced on the cathode to produce H₂ gas and OH. The H₂ gas bubbles out and the OH⁻ reacts with the CO₂ in the input steam to produce HCO₃⁻. The continuous production of OH⁻ ensure continuous capture of CO₂ as HCO₃⁻.

Capture units 10 of the disclosure can further include a cathode 20 arranged in or upstream of the non-aqueous region 14 whether for operation as a membrane-electrode unit or for use with capture units having CO₂ binding organic liquids in the non-aqueous region. The cathode 20 can function to reduce H₂O to H₂ gas and OH⁻ which can be a source for the binding of CO₂ and conversion to HCO₃⁻ in the non-aqueous region n14. An H₂ outlet 28 can be arranged such that the H₂ gas bubbling out from the reduction of H₂O is vented from the unit 10.

Capture units 10 of the disclosure can further include an anode 22 arranged downstream of the aqueous region. In capture units 10 of the disclosure having cathodes 20 and anodes 22, the aqueous region 16 can include an aqueous electrolyte and an electric field can be applied within the capture unit to facilitate migration and diffusion of the HCO₃⁻ from the non-aqueous region 14 to the aqueous region 16. In embodiments, the electric field can be generated and applied within the capture unit.

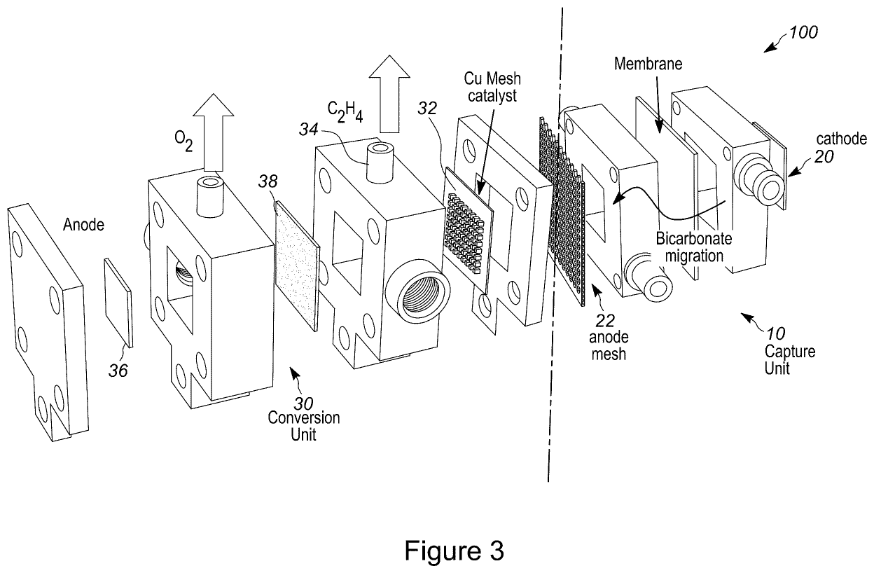

Either or both of the anode 22 and cathode 20 can be planar and/or porous. Referring to FIG. 3, in systems 100 of the disclosure having capture units 10 and reduction units 30, the cathode 20 can be arranged upstream of the capture unit and the anode 22 can be arranged downstream of the reduction unit 30, as described in detail below.

The non-aqueous region 14 can include a CO₂ binding organic liquid containing OH⁻ which is arranged to be in contact with the input gas to chemisorb CO₂ from the input gas and convert the chemisorbed CO₂ into HCO₃⁻ by reaching with the OH⁻ and/or a source for OH⁻. The CO₂ binding organic liquid can be for example an ionic liquid. The ionic liquid can be imidazolium-or phosphonium-based. For example, the ionic liquid can be one or more of choline hydroxide, tetrabutylphosphonium methanesulfonate, and 1-Butyl-3-methylimidazolium hexafluorophosphate.

The hydroxide ion source can be, for example, an alkali metal hydroxide. The hydroxide ion source can be dissolved in the CO₂ binding organic liquid. For example, the hydroxide ion source can be KOH.

The non-aqueous region 14 can further include a non-aqueous polar organic solvent. The non-aqueous polar solvent can be one or more of alcohols, organic amidine bases, or guanidine bases. The amidine or guanidine bases can chemically bind with CO₂ as liquid amidinium or guanidinium alkylcarbonate salts. For example the solvent can be one or more of ethylene glycol, methanol, and ethanol.

The unit 10 can alternatively operate as a membrane-electrode unit in which a cathode 20 is provided upstream of the non-aqueous region 14 and the anion exchange membrane 18 has a dry side which functions to bind the CO₂ from the input gas stream on the non-aqueous region 14 of the unit. The anion exchange membrane 18 can be or include a quaternary amine which has OH⁻ ions associated around the quaternary amine. The OH⁻ reacts with the CO₂ to form HCO₃⁻ which migrates across the anion exchange membrane as describe herein. In such a unit 10, H₂O is reduced by the cathode to produce H₂ gas and OH⁻. The H₂ gas bubbles out and the OH⁻ reacts with the CO₂ in the input steam to produce HCO₃⁻. The continuous production of OH⁻ ensure continuous capture of CO₂ as HCO₃⁻. In some units 10, the anion exchange membrane 18 can be coated with a CO₂ binding agent to further facilitate binding as in the systems using the CO₂ organic binding liquid.

The aqueous region 16 includes H₂O either in a liquid form such as the presence of water itself or an aqueous electrolyte, or as humidified gas (collectively referred to herein as an aqueous fluid). The aqueous fluid can be flowed through the aqueous region or can be provided in a fixed amount. In the aqueous region HCO₃⁻ interacts with H₂O and decomposes to CO₂ and CO₃²⁻.

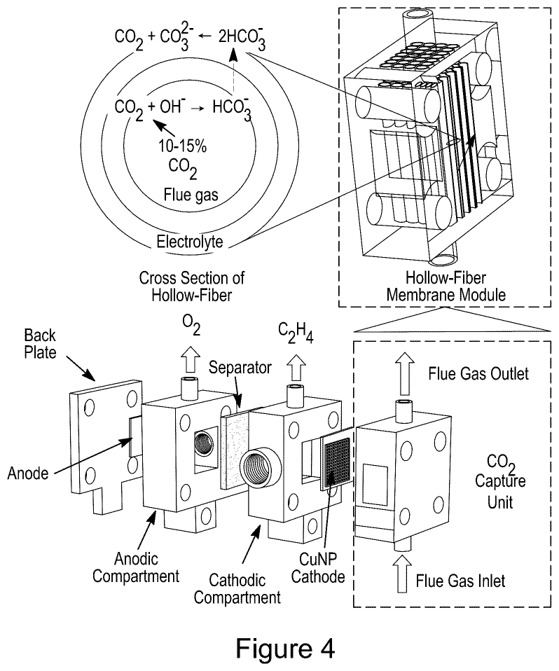

The anion exchange membrane 18 can include one or more quaternary amines or phosphonium ions. The anion exchange membrane can be, for example, a polymer backbone resin with hydroxide, carbonate, and/or bicarbonate moieties to which the quaternary amines or phosphonium ions are attached. The polymer backbone can be, for example, a polystyrene. Referring to the inset of FIG. 4, the anion exchange membrane can be composed of hollow fibers. The anion exchange membrane can be formed of materials capable of withstanding high pH, such as a pH of greater than 10. For example, the presence of hydroxide, carbonate, and bicarbonate moieties on the polymer backbone as counter ions can help enable the anion exchange membrane from sustaining pH greater than 10.

The rate of capture can be tuned by adjusting the specific area of the anion exchange membrane. Higher specific area configurations, such as hollow-fibers or porous carbon or other suitable substrates can increase the rate and amount of CO₂ capture. For example, an anion exchange membrane hollow fiber structure having a specific area of 527 cm² per 1 cm² of the geometric area can supply CO₂ from ambient air to a cathode to support 350 mA/cm² of current density while maintaining steady-state CO₂ concentration in the electrolyte to 22 mM. This compares well with experimentally measured CO₂ capture flux of about 100 μmol m⁻² s⁻¹ using capture unit 10 in accordance with the disclosure.

The capture unit 10 can further include an input gas outlet 24 in fluid communication with the input gas, such that the input gas flows into the capture unit 10 through the input gas inlet 12 for capture of the CO₂ and remaining components of the gas are removed from the unit 10 through the input gas outlet 24.

The input gas is any gas containing CO₂ and from which the CO₂ is to be captured. For example, the input gas can be a dilute source of CO₂ such as a flue gas, other industrial gas, air, or other source of anthropogenic CO₂. Dilute sources of CO₂ can include flue gas containing about 10-15% CO₂ in the stream and air containing greater than about 400 ppm of CO₂. The input gas can be at a temperature of about 20° C. to about 120° C.

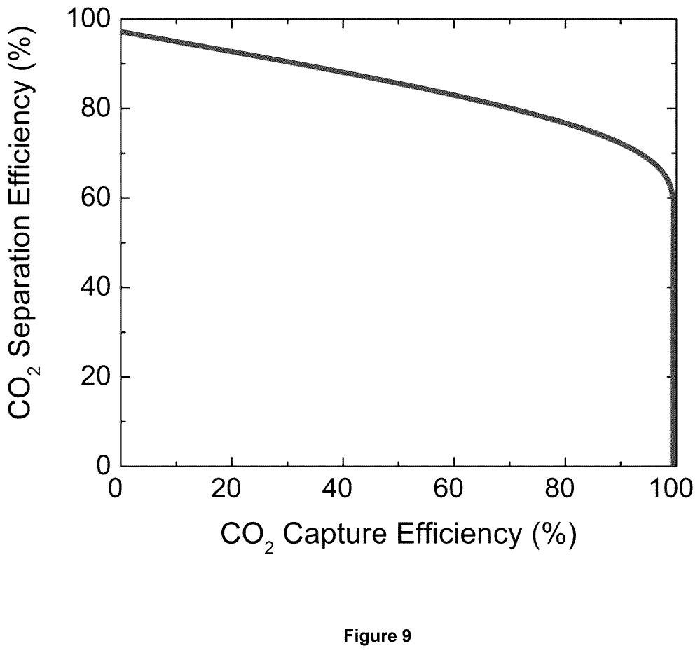

Capture units of the disclosure can achieve high separation efficiency while maintaining CO₂ capture efficiency. Referring to FIG. 9, for example, the CO₂ capture efficiency of about 80% can be maintained while achieving a CO₂ separation efficiency of 80%. Capture units and systems of the disclosure can have CO₂ separation efficiency and/or CO₂ capture efficiency between 60% and 90%. Capture efficiency and separation efficiency are calculated as follow:

$$\begin{matrix}Separation efficiency = \frac{{C}_{{CO}_{2}} ( dry )}{{C}_{{CO}_{2}} ( wet )} \times 100 \\ Capture efficiency = \frac{{CO}_{2} capture flux}{{CO}_{2} capture flux + {CO}_{2} crossover flux} \times 100\end{matrix}$$

Wherein “dry” refers to the nonaqoues regoin and “wet” refers to the aqueous region.

Capture units and systems for capture and reduction of the disclosure can operate at ambient conditions. Capture units and capture and reduction systems of the disclosure can operate in low humidity environments. This advantageously allows the capture unit to be used in a variety of manufacturing or other environments, such as indoor in residential, commercial, or industrial settings, as well as outdoor in open areas.

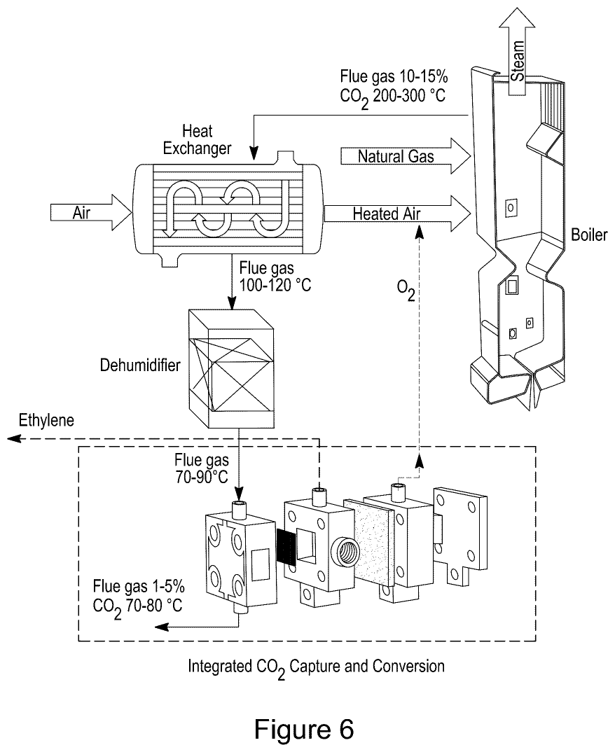

Referring to FIGS. 3 and 4, a system 100 for active CO₂ capture and reduction can include any of the capture units 10 described herein with a reduction unit 30 for converting the captured CO₂ into a desired product gas. Desired product gases include one or more of C₂H₄, C₂H₅OH, CH₃COOH, C₃H₆, CH₃OH, CH₄, CO, and H₂. The system can have integrated capture and reduction. Referring to FIG. 6, a system can be configured to receive dehumidified flue gasses from a boiler system and have delivery outlets configured to release converted output gasses from the system. The system of the disclosure can be tuned to produce CO and H₂ (syngas) which can be recycled to act as secondary fuels for the boiler for continuous operation.

The reduction unit 30 is arranged downstream of the active CO₂ capture unit 10 such that the reduction unit receives the captured CO₂ from a CO₂ capture outlet arranged at the aqueous region in which the captured CO₂ is released through reaction with H₂O. The reduction unit includes catalyst 32 for reduction of the captured CO₂, such that when the captured CO₂ is flowed into the reduction unit 30, it interacts with the catalyst 32 to be reduced to one or more of C₂H₄, C₂H₅OH, CH₃COOH, C₃H₆, CH₃OH, CH₄, CO, and H₂. The system 10 further includes a catalyst for oxidation of H₂O 36 for generation of protons for CO₂ reduction and O₂ as a byproduct. A separator 38 is disposed between the reduction unit 30 and the H₂O oxidation catalyst 36. The H₂O oxidation catalyst 36 can be part of or otherwise form an anode for the system. The H₂O oxidation catalyst can include, for example, one or more of Ni, Fe-Ni, Pt-coated Ti, Ir, and Ru. In the system the cathode can be provided upstream of the capture unit or part of the capture unit as described herein. The system can also include an energy source. The energy source can be, for example, a photocell and/or electrochemical cell. The energy source can be integrated with the carbon capture unit 10 or can be integrated within the system into a standalone device.

The CO₂ reduction catalyst can be a copper mesh. For example, the copper mesh can have a mesh size of about 40 to about 120 mesh. Suitable mesh sizes include about 40, 45, 50, 55, 60, 65, 70, 75, 80, 85, 90, 95, 100, 105, 110, 115, and 120, and any values there between or ranges defined by values there between.

The CO₂ reduction catalyst can include or be formed as metal nanocrystals. For example, the metal nanocrystals can be grown on a mesh substrate. For example, Cu nanocrystals can be used as the CO₂ reduction catalyst. The Cu nanocrystals can be Cu nanocubes having dominate (100) facets. The catalyst can be prepared, for example, by spray coating Cu-nanocube nanoparticle ink onto carbon paper or electrodeposition or the like. The metal nanocrystals can be formed into different sizes and shapes and formed by cyclic oxidation-reduction of polycrystalline metal films, such as Cu

In systems of the disclosure, the CO₂ capture unit 10 and the reduction unit 30 can be spaced a distance of about 5 mm to about 20 mm.

A method for capturing CO₂ can include flowing an input gas containing the CO₂ to be captured into a CO₂ capture unit as described herein. Upon introduction of the input gas into the non-aqueous region of the capture unit, a CO₂ binding organic liquid comprising OH⁻ and/or OH present on or associated with the anion exchange membrane chemisorbs the CO₂ and converts to HCO₃⁻. The HCO₃⁻ migrates across the anion exchange membrane, at which a gradient of moisture exists into the aqueous region. The gradient of moisture facilitates transport across the membrane. The method can further include application of an electric field across the capture unit to further assist in transport of the HCO₃⁻ across the membrane. The applied electric field can be applied as a static voltage in the range of about 3 to about 10 V. Optionally the applied electric field can be generated within the system. In the aqueous region, the HCO₃⁻ interacts with H₂O present in the aqueous region and decomposes to CO₂, which can be flowed to a captured CO₂ outlet.

As discussed above, the capture unit or system containing the capture unit 10 can include a cathode 20, at which H₂O is reduced to H₂ and OH⁻. The H₂ bubbles out and can be released upstream of the capture unit and the OH⁻ can be flowed into the non-aqueous region for binding of the CO₂. Water can be continuously flowed as humidified nitrogen into and/or recirculated through the capture unit to provide a continuous source of OH⁻ to the non-aqueous region for continuous binding operation. The H₂ released from the reduction of H₂O by the cathode can be used to power the reduction unit or can be oxidized to generate protons for the reduction.

In systems of the disclosure further including a reduction unit, the CO₂ captured and released from the capture unit is flow into the reduction unit where it interacts with a CO₂ reduction catalyst that reduces the CO₂ to one or more desired product gas 34. The anode arranged downstream of the cathode can serves as a catalyst for oxidation of H₂O, and reduces the H₂O to provide protons to the reduction catalyst. The oxidation of H₂O by the anode results in the production of O₂ as a byproduct. The system advantageously separates the oxidation of H₂O spatially from the reduction of the CO₂ by having a spacer arranged between the H₂O oxidation catalyst (the anode) and the reduction unit. This advantageously separates the O₂ byproduct gas stream from the product gas stream 34 to provide a high purity product gas stream.

The systems of the disclosure can be an integration of the active CO₂ capture unit and CO₂ reduction unit with a flowing of electrolyte in the aqueous side of the CO₂ capture unit to the cathode compartment of the CO₂ reduction unit.

### Theoretical Modeling

A one-dimensional model for moisture-gradient membrane adjacent to an aqueous electrolyte was developed as seen in FIG. 1B using COMSOL Multiphysics to solve Nernst-Planck equation for the transport of different ionic species. A time dependent analysis was done to see the development of concentration profiles of the species in the membrane. The carbonate-bicarbonate equilibrium reactions were set to be water-dependent and the adjacent electrolyte was modeled as a well-mixed electrolyte with high diffusion coefficients for all the species.

Species considered in the model: Based on the proposed moisture-gradient mechanism for CO₂ capture, a total of 8 species were considered in the simulation: i) CO₂ as the main species for moisture-gradient capture, ii) H₂O for the moisture content on the dry side and also in the electrolyte adjacent to the membrane contributing to the moisture gradient, iii) H⁺ from dissociation of H₂O, iv) OH⁻ from dissociation of H₂O and for CO₂ capture from Step 1 of the moisture-gradient mechanism, v) HCO₃⁻ for the water-dependent equilibrium kinetics in the membrane, vi) CO₃²⁻ also for the water-dependent equilibrium kinetics, vii) K⁺ counter ion to carbonates and bicarbonates in the membrane and the adjacent electrolyte and does not contribute to moisture-gradient mechanism, and viii) NR₄⁺ as the background quaternary amine on the membrane.

Transport of species: Only diffusion and ionic mobility due to the applied electric field were assumed to be driving the transport of the species in the absence of convection. Since the transport mechanism is facilitated by the concentration of water, the diffusion was also dependent on the water uptake A of the membrane which in turn is dependent on the water concentration on the dry side. A is defined as the concentration of water per unit concentration of the membrane background (NR). The governing equation used in the model was:

$$\frac{\partial {C}_{j}}{\partial t} + ∇ \cdot {J}_{j} = {R}_{j} \qquad ( 1 )$$

where Cⱼ is the concentration, Jⱼ is the flux, and Rⱼ is the reaction rate of the of the j^{th} species. The total diffusive and ionic mobility flux is given by:

$${J}_{j} = - {D}_{j} ∇ {C}_{j} - {z}_{j} {u}_{m , j} {FC}_{j} ∇ V \qquad ( 2 )$$

where Dⱼ is the λ dependent diffusion coefficient Dⱼ(λ), zⱼ is the charge number, u_{m,j} is the ionic mobility of the j^{th} species. F is the Faraday's constant and V is the potential. Since we are solving Nernst-Planck equation but there's no applied potential at the membrane, an electroneutrality condition is imposed by:

$$Σ {z}_{j} {C}_{j} = 0 \qquad ( 3 )$$

Reactions in membrane: The moisture-gradient CO₂ capture is implemented using water-dependent carbonate bicarbonate equilibrium reactions. The H₂O dissociation reaction considered in the model was:

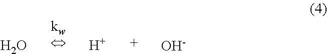

The carbonate-bicarbonate equilibrium reactions are given by:

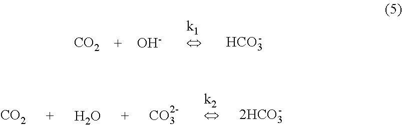

The activity of H₂O in all the reactions in the membrane is not considered to be unity and was calculated as λ×[NR₄⁺].

Boundary conditions: On the dry side of the membrane, an inward flux of the CO₂ feed was established as:

$${N}_{i , {CO}_{2}} = - n \cdot {J}_{C {O}_{2 , feed}} \qquad ( 6 )$$

where N_{i,CO}_{₂} is the inward flux determined from the CO₂ capture kinetic experiments and −n is the normal vector pointing inward in the model. To implement a complete carbon dioxide capture and utilization process, the moisture-gradient CO₂ capture was combined with electrochemical utilization of CO₂ to CO. This electrochemical integration was implemented in the form of a boundary condition as a flux of CO₂ removal given by:

$${N}_{o , {CO}_{2}} = - {F}_{{CO}_{2}} \qquad ( 7 )$$

where N_{o,CO}_{₂} is the outward flux of CO₂ and the flux of CO₂ F_{CO}_{₂} is given by:

$${F}_{{CO}_{2}} = \frac{I}{n F} \qquad ( 8 )$$

where I is the current density of CO₂ utilization and n is the number of electrons transferred for the conversion of CO₂ to CO (n=2).

### EXAMPLES

### Example 1: Simulated Capture Process

As the H₂O concentration decreases on the non-aqueous “dry” side, the equilibrium constant also decreases to favor the formation of HCO₃⁻. A continuum model using COMSOL Multiphysics software can be used to simulate the moisture-gradient-driven CO₂ capture process. The objective of these simulations is to quantify the effects of physical properties of AEM such as water sorption, water permeability, ion-exchange capacity, ion conductivity, ion selectivity, CO₂ crossover, porosity, and membrane thickness on three key performance metrics, namely, CO₂ capture efficiency (defined as the ratio of CO₂ capture flux to the sum of CO₂ capture and CO2 crossover fluxes), CO₂ separation efficiency (defined as the ratio of captured CO₂ concentration at the aqueous “wet” side to the CO₂ concentration in the absence of CO₂ crossover), and energy requirement (defined as the total energy consumed per mole of CO₂ captured).

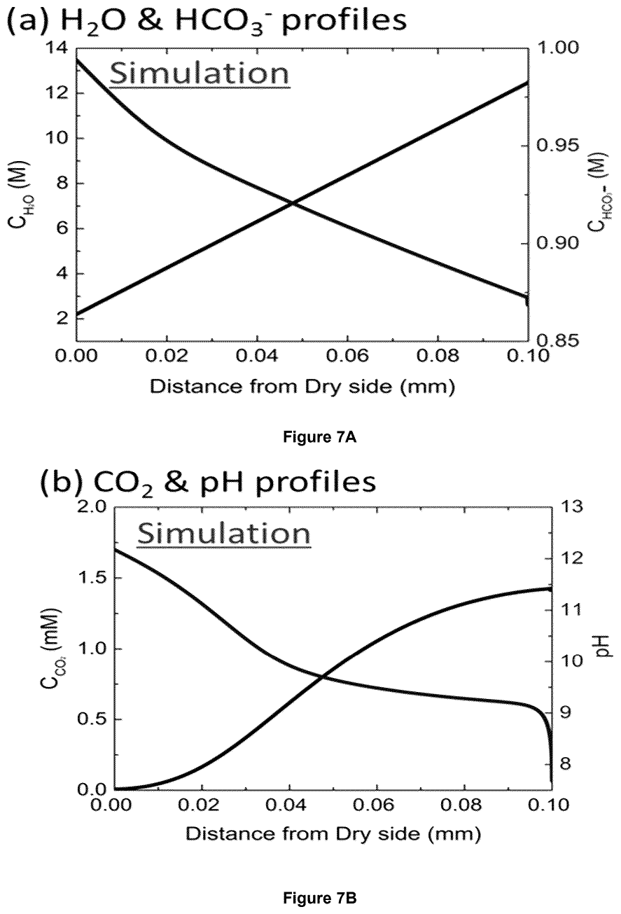

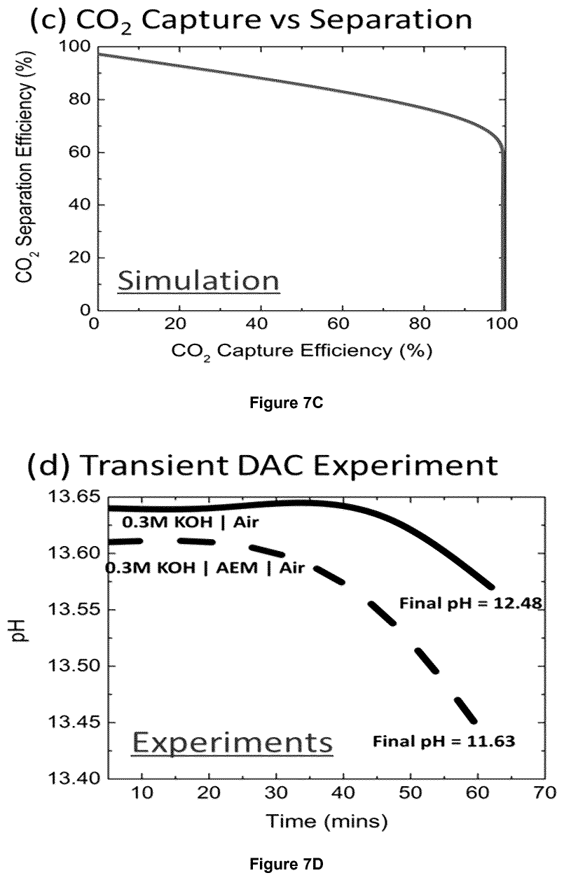

FIG. 7A shows the counter-diffusion of H₂O and HCO₃⁻ in the membrane when RH of the “wet” side is 100%, and the “dry” side is 20%. The flux of HCO₃⁻ governs the CO₂ capture flux. The increase in the CO₂ concentration on the “wet” side increases the back-diffusion or crossover of CO₂ to the “dry” side, which is shown in FIG. 7B along with the pH gradient inside the membrane.

The crossover loss of CO₂ can be minimized by direct utilization of CO₂ on the “wet” side. The computed performance curve for the Excellion AEM is given in FIG. 7C, which shows the CO₂ separation efficiency decreases with an increase in the CO₂ capture efficiency. This behavior is due to a decrease in the CO₂ concentration on the “wet” side with an increase in CO₂ utilization flux, which is equal to CO₂ capture flux at steady-state. The ideal shape of the performance curve should be square, such that CO₂ separation efficiency is 100% for varying values of CO₂ capture flux or efficiency. This performance curve will be matched with the CO₂ utilization (conversion) efficiency of one or more suitable catalysts in the integrated system.

Moreover, the effectiveness of the moisture-gradient process to capture CO₂ from the air can be experimentally evaluated. FIG. 7D shows the experimentally measured pH change when air was directly sparged to 0.3M KOH electrolyte, as compared to the case when AEM (Excellion) is used as a contactor. The decrease in pH was found to be directly related to the increase in CO₂ concentration in the electrolyte. The difference between the final pH (measured after 5 hours) in both cases was>1 unit, which indicates an order of magnitude higher moles of CO₂ captured using a moisture-gradient process.

The specific area of AEM used here was 1 cm²/cm². The rate and amount of CO₂ capture can be substantially improved by using higher specific area configurations such as a hollow-fiber module or porous carbon or other suitable substrates.

### Example 2

FTIR spectroscopy: FTIR spectroscopy was performed to quantify the concentration of CO₃²⁻ and HCO₃⁻ for varying H₂O concentration in a non-aqueous solvent (CH₃OH) to understand the shift in the equilibrium as a function of the concentration of water. The FTIR bench was a Bruker Invenio S with a Pike VeeMax II variable angle attenuated total reflectance (ATR) accessory and a 60° Ge face-angled crystal. A mid-band liquid N₂ cooled MCT detector was used, and for each experiment, the spectra acquired were averaged over 1500 acquisitions at a resolution of 4 cm⁻¹. The intensity of HCO₃⁻ band at 1633 cm⁻¹ and the CO₃²⁻ band at 1450 cm⁻¹ were individually calibrated at different concentrations of HCO₃⁻ and CO₃²⁻ in CH₃OH. A custom-made 3D printed cell of maximum capacity 4 ml was placed on top of the Ge crystal, where all the FTIR experiments were performed.

Initially, known amounts of NaHCO₃ were dissolved in pure CH₃OH and the spectra taken showed the increase in the intensity of one of the HCO₃⁻ stretching bands with the increase in its concentration at 1633 cm⁻¹. CH₃OH was chosen as a solvent to retain the HCO₃⁻ in their pure form and prevent them from equilibrating with CO₃²⁻ as seen in an aqueous system. HCO₃⁻ were calibrated by relating the known concentration of NaHCO₃ dissolved in CH₃OH to the intensity at 1633 cm⁻¹. Similarly, the CO₃²⁻ were calibrated by observing the change in the intensity at 1450 cm⁻¹.

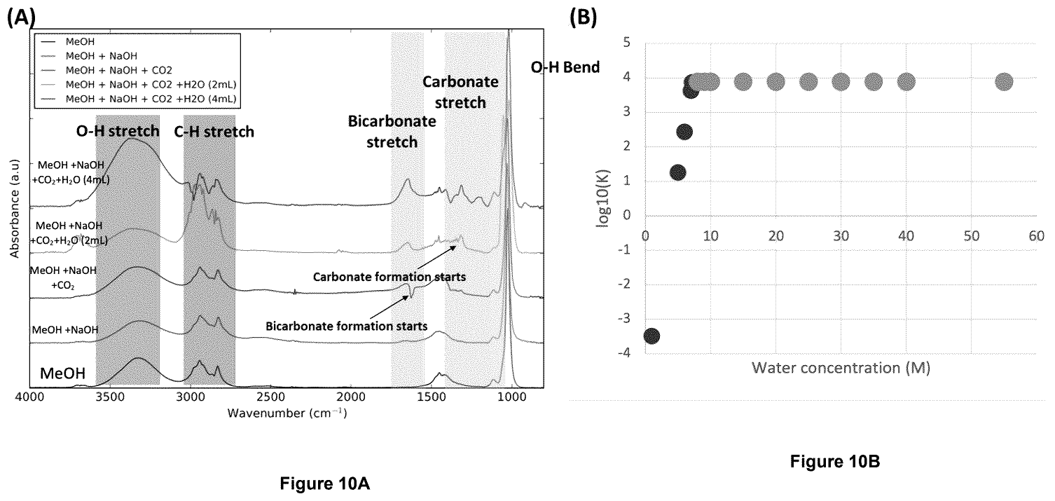

To study the equilibrium kinetics, a known amount of NaOH was dissolved in CH₃OH and CO₂ was sparged into the system, resulting in the conversion of OH⁻ to HCO₃⁻. The concentration of HCO₃⁻ was determined using the previously established calibration curve. A small amount of H₂O was added to this solution and the spectra were recorded to quantify CO₃²⁻ formed via HCO₃⁻ decomposition (see FIG. 10A). The same experiment was repeated with increasing quantities of H₂O to quantify the H₂O-dependent equilibrium constant (see FIG. 10A). Since the equilibrium of bicarbonate decomposition reaction also produces H₂O when the reaction shifts from HCO₃⁻ to CO₃²⁻, the quantity of H₂O in the solution is larger than the quantity added. This extra H₂O was quantified by Karl-Fisher (KF) Titrations

Karl Fischer titration: KF titrations were performed to determine the total water content in the system containing the previously determined HCO₃⁻ and CO₃²⁻. A custom-made 3D-printed cell of the same capacity as the cell used in the FTIR was used for this study. A solution of CH₃OH, NaHCO₃, and a known amount of H₂O in the cell was well mixed using a magnetic stirrer. Two Cu electrodes were placed on the opposite ends of the cell and the open circuit potential (OCP) of the cell was constantly monitored. 20 μl of KF titrant was added to the cell periodically and the endpoint was detected by a sharp increase in the OCP of the cell. This endpoint is an indicator of the total H₂O in the solution. Therefore, the combination of FTIR and KF titrations can provide HCO₃⁻, CO₃²⁻ and H₂O concentration and the equilibrium constant for 2HCO₃⁻→CO₂+CO₃^{2-+H}₂O can be calculated using the equation below-

$$K = \frac{[ {CO}_{2} ] [ {CO}_{3}^{2 -} ] [ {H}_{2} O ]}{{[ H C {O}_{3}^{-} ]}^{2}} \approx \frac{{[ C {O}_{3}^{2 -} ]}^{2} [ {H}_{2} O ]}{{[ H C {O}_{3}^{-} ]}^{2}}$$

Here

$$[ {CO}_{2} ] = {[ CO}_{3}^{2 -} ]$$

because of the reaction stoichiometry and CO₂ concentration is much smaller than the solubility limit. FIG. 10B shows a linear increase in log₁₀ K with increasing H₂O, which reaches a plateau of ˜3.87 around 8 M H₂O concentration.

Kinetics of CO₂ capture: CO₂ capture experiments were performed using a basic organic solution consisting of 1.2M KOH dissolved in a CO₂ organic binding liquid comprised of 80% ethylene glycol (EG) and 20% choline hydroxide (CH). Ethylene glycol was used as a non-aqueous solvent due to the higher solubility of KOH and its higher boiling point (˜197° C.), and CH was used for its high affinity for CO₂ capture. CO₂ was sparged into the solution where it reacts with the OH⁻ from the dissolved KOH to form HCO₃⁻.

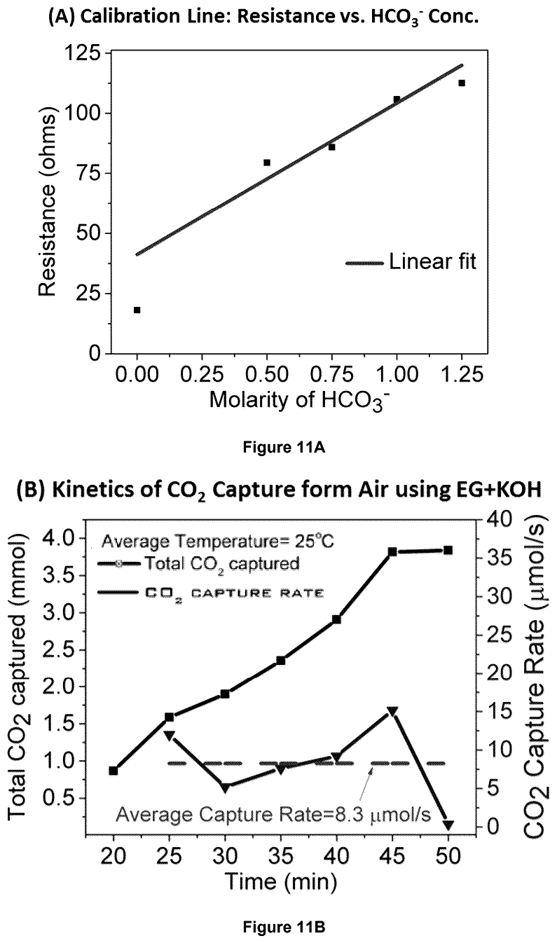

First, a calibration curve was obtained by measuring the variation in the resistance of the organic solution with an increase in the HCO₃⁻ concentration. The calibration solutions had a fixed K⁺ concentration of 1.2M and varying HCO₃⁻/OH concentrations. The resistance of the solution was measured using electrochemical impedance spectroscopy (EIS). FIG. 11A shows almost linear variation in resistance of solution with increasing mole fraction of HCO₃⁻, which can be used to determine CO₂ chemisorbed as HCO₃⁻.

An efficient gas sparger of ˜2 μm size was used to increase the contact of air with the organic solution of ˜3 ml volume at room temperature (˜20° C.). The dynamic change in the resistance of the solution was converted into HCO₃⁻ concentration using the calibration curve. FIG. 11B shows a steady increase in the moles of CO₂ absorbed in the solution with an average rate of ˜_{8.3} μmol/s. The rate of CO₂ capture can be increased by using ionic liquids with high CO₂ solubility. These ionic liquids will increase the dissolved concentration of molecular CO₂, which will then increase the rate of CO₂ chemisorption with OH⁻.

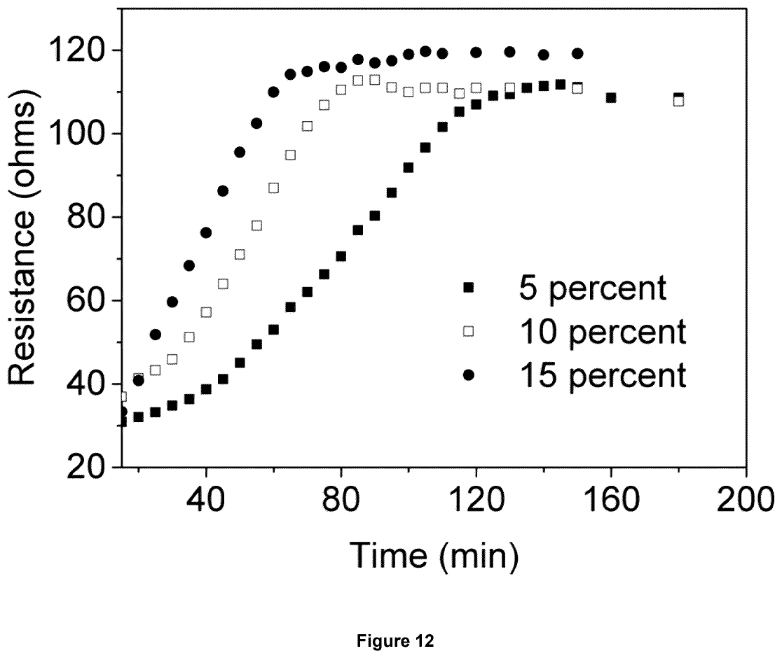

The amount of CO₂ captured on the dry side of the unit was quantified by conversion of hydroxide to bicarbonate formation. Referring to FIG. 12, it was observed that the higher the concentration of the CO₂ in the input gas, the less time required to completely saturate with bicarbonate ions.

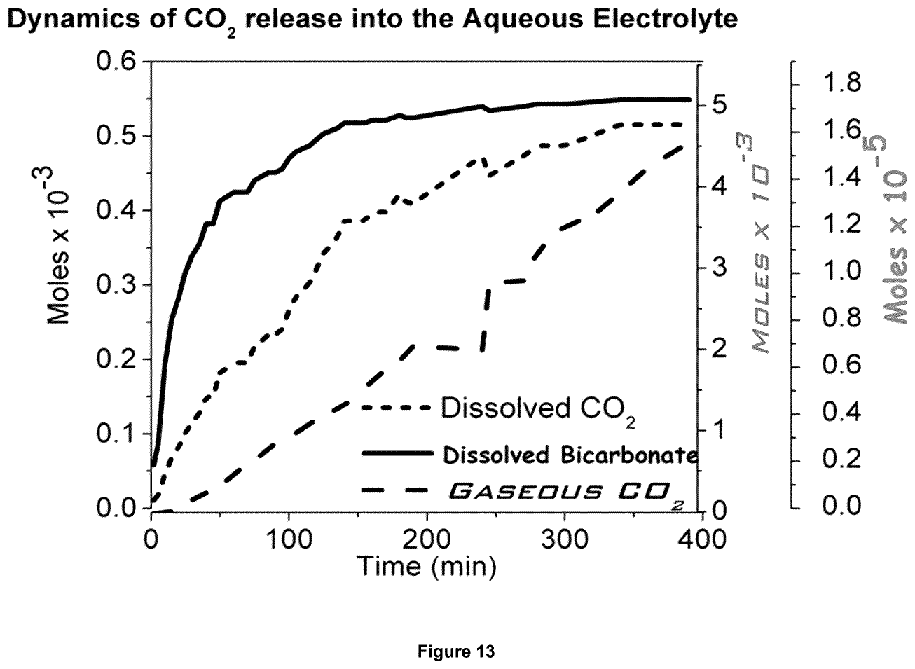

Dynamics of CO₂ Transport and Release: Under the applied electric field, HCO₃⁻ in organic solution will migrate towards aqueous electrolyte and decrease its pH over time. An electrochemical cell shown in FIG. 2 was used to measure the current and pH change in the aqueous electrolyte. The CO₂ release experiment was performed using chronopotentiometry, where the total current was fixed to ₂₅ mA. Since HCO₃⁻ was the majority charge carrier in organic solution and anion exchange membrane, the rate of HCO₃⁻ migrated is directly proportional to the current (/) such that r_{HCO}_{₃}_{^{−}}=I/F, where F is Faraday's constant. The measured pH and r_{HCO}_{₃}_{^{−}} can be used to calculate the concentration of HCO₃⁻, CO₃²⁻, dissolved CO₂ and gaseous CO₂, which are shown in FIG. 13. The majority of carbon species in the aqueous solution are dissolved and gaseous CO₂. While the dissolved CO₂ plateaus around 250 mins, the gaseous CO₂ (dotted line) is continuously released from the solution at a steady rate. The experimentally measured moles of CO₂ released over 6 hr had a record flux of 2.3 mmol/m²s.

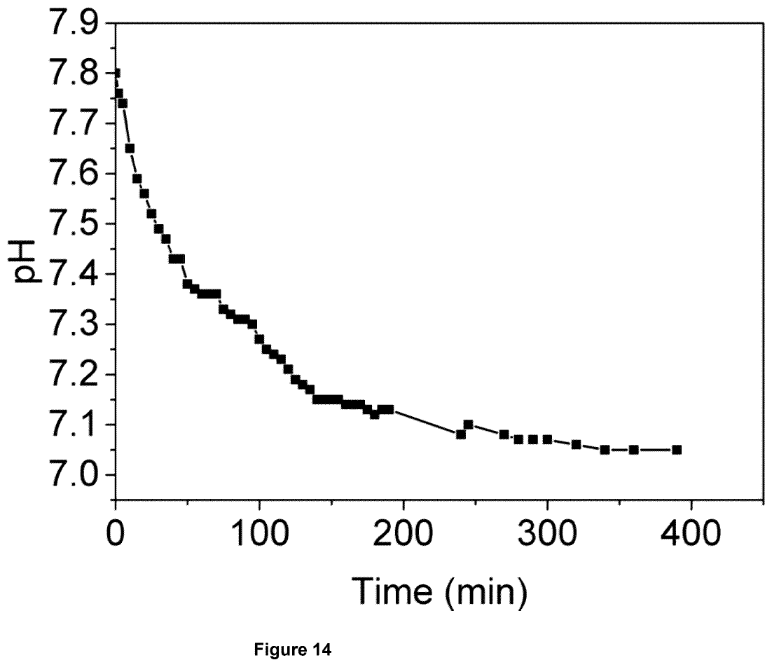

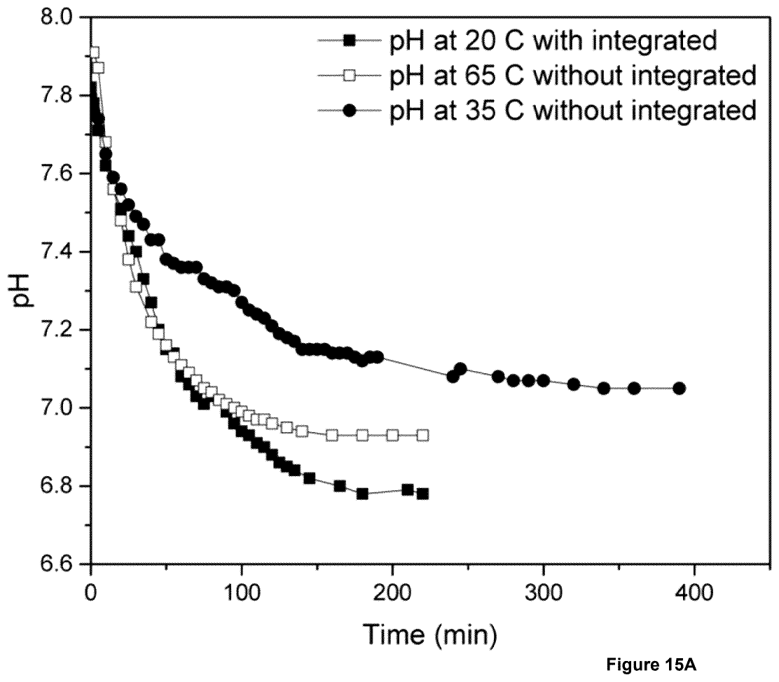

Referring to FIG. 14, the amount of CO₂ migrated with time was quantified by observing a pH drop on the wet-side.

Since the electrochemical cell had an anion exchange membrane area of 4 cm², the total rate of CO₂ transport and release was ˜1 μmol/s which was ˜8 times smaller than the CO₂ capture rate in FIG. 11. Therefore, the maximum CO₂ release rate of ˜8 μmol/s can be achieved by either increasing the current or membrane area by 8 folds. The energy consumption of this process is primarily determined by the applied cell potential, which was ˜6 V for the current process. It was observed that he applied cell potential can be substantially decreased by adding ionic liquids, which will also increase the CO₂ capture capacity of the organic solution. It was also observed that he ionic liquid properties can also be tuned to decrease the H₂O uptake of the organic solution.

Table 1 shows a comparison of CO₂ capture fluxes of various prior known materials and the materials of the disclosure.

TABLE 1
Comparison of CO₂ capture fluxes for known materials

| Material | Type | CO₂ Flux (mmol/m²-s) |
|---|---|---|
| Moisture-gradient of the | Solid | 1.21E−06 |
| present disclosure | | |
| K₂CO₃/AC | Solid | 1.21E−06 |
| ALUMINA/DETA | Solid | 6.31E−04 |
| NANOCLAY W/AMINE | Solid | 9.47E−05 |
| PMMA W/AMINE | Solid | 8.87E−07 |
| SiO₂ + PEI | Solid | 6.29E−05 |
| AL—CaO MOF | Solid | 5.77E−05 |
| POLYAMINE-PHOSP | Solid | 3.31E−05 |
| PMMA + TEPA | Solid | 2.62E−06 |
| CeO₂ | Solid | 1.51E−09 |
| TMAG on PMMA | Solid/liquid | 1.04E−06 |
| TEPA NO₃ on SiO₂ | Solid/liquid | 6.67E−05 |
| SiO₂ + ionic liquids | Solid/liquid | 1.29E−06 |
| ZrP/BMIMCl | Solid/liquid | 8.47E−07 |
| EMIM lys PMMA | Solid/liquid | 9.00E−07 |
| Ionic liquid + graphene oxide | Solid/liquid | 3.37E−07 |
| [bmim][acetate]-ENIL | Solid/liquid | 1.89E−06 |
| Piperizine | Liquid | 2.00E−06 |
| MEA + nanoparticles | Liquid | 1.6E−02 |

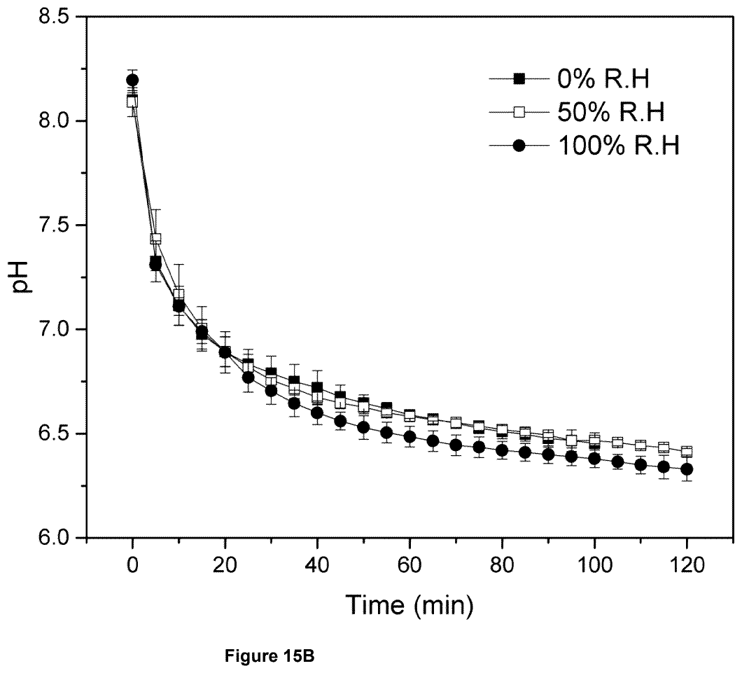

FIG. 15A shows the effect of the integration of both capture and reduction processes on the migration process. As shown in FIG. 15, improved performance resulted from integration because a constant source of bicarbonate ions was present. The aqueous electrolyte used in this set-up was 0.1M KOH.

FIG. 15B shows the effect of humidity on the migration process. In this test, the aqueous electrolyte was 1 M KCI and 0.1M KHCO₃. The non-aqueous capture solution was maintained at about 95° C. and the simulated input gas was a flue gas at 25° C.

### Example 3: Reduction

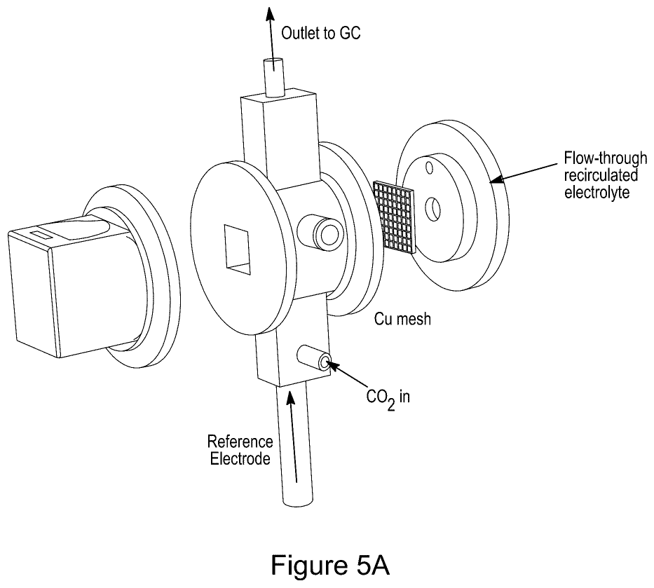

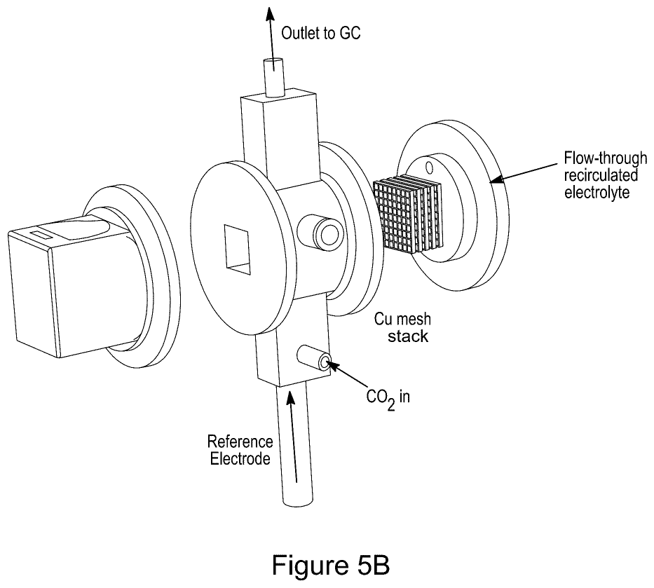

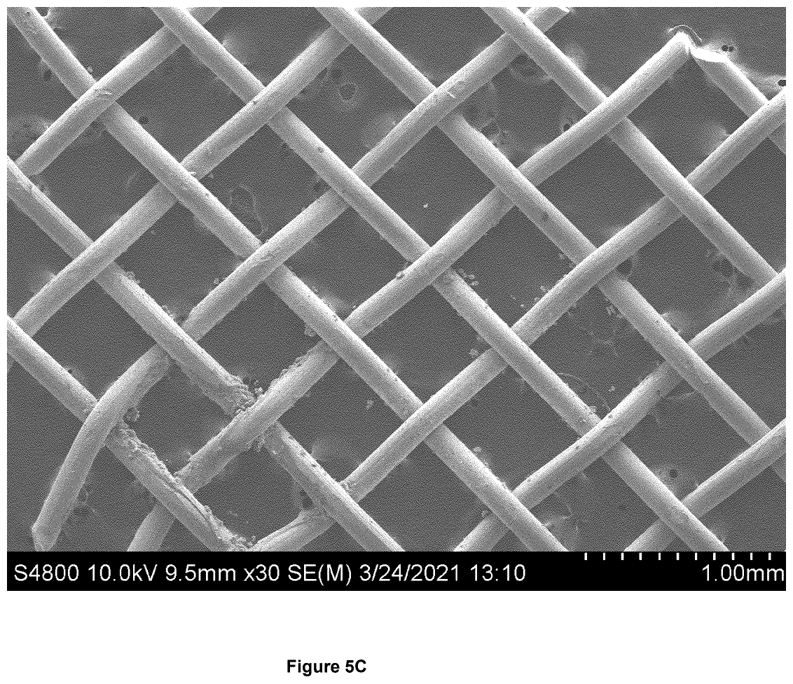

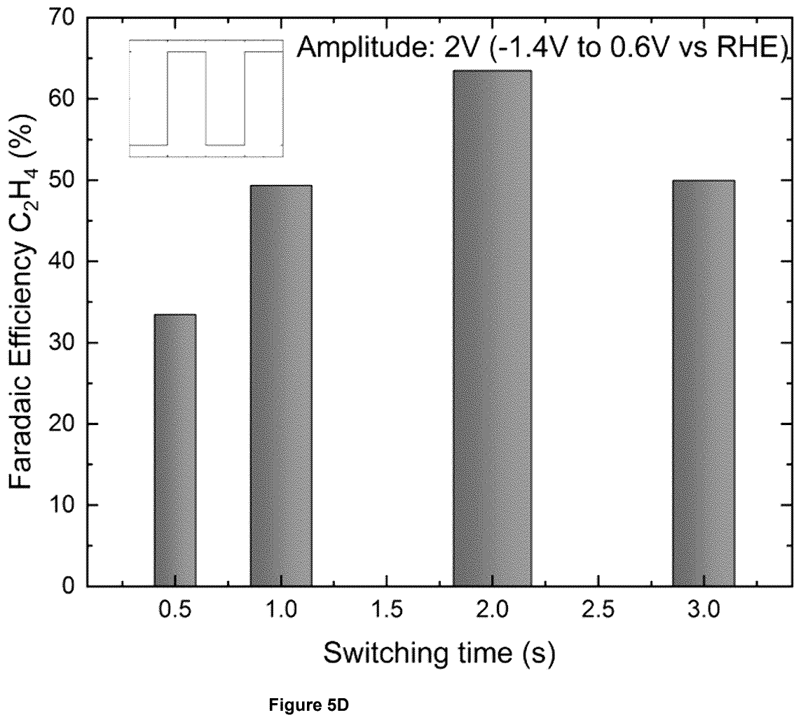

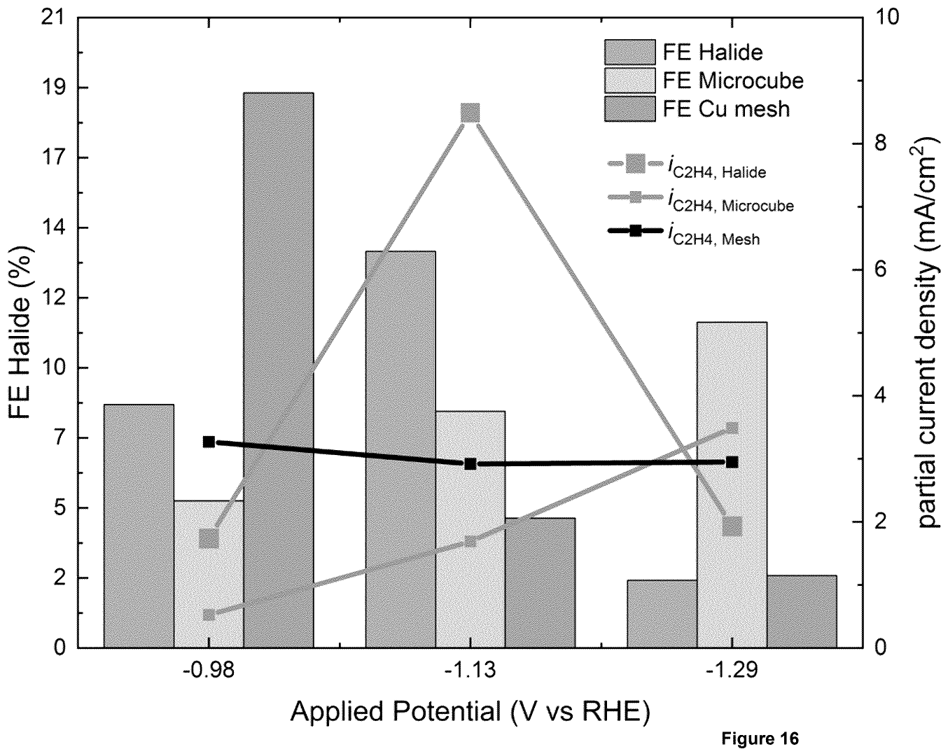

Various reduction catalysts were tested inlcuding Halide mediated Cu, micro-cubic Cu, and Cu mesh. Cu mesh was observed to provide the highest reduction efficiency as shown in FIG. 16. The experimental set up used is shown in FIG. 5A.

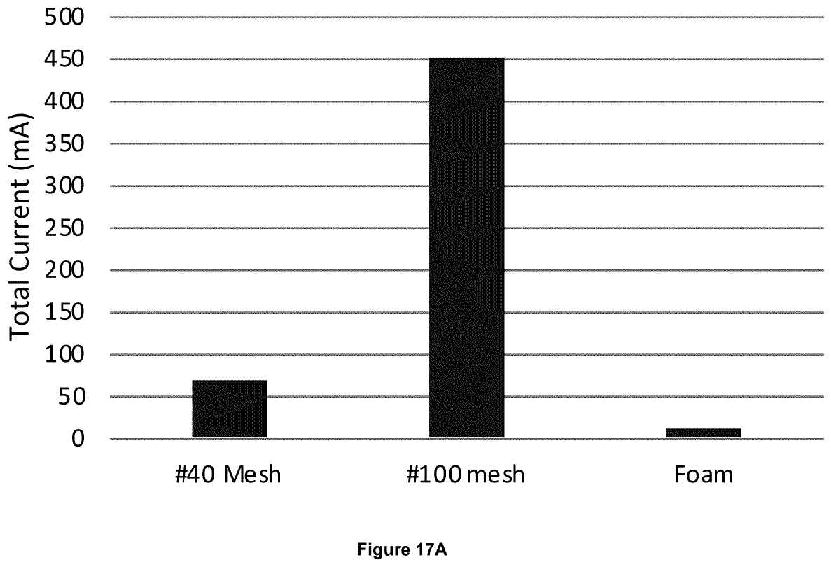

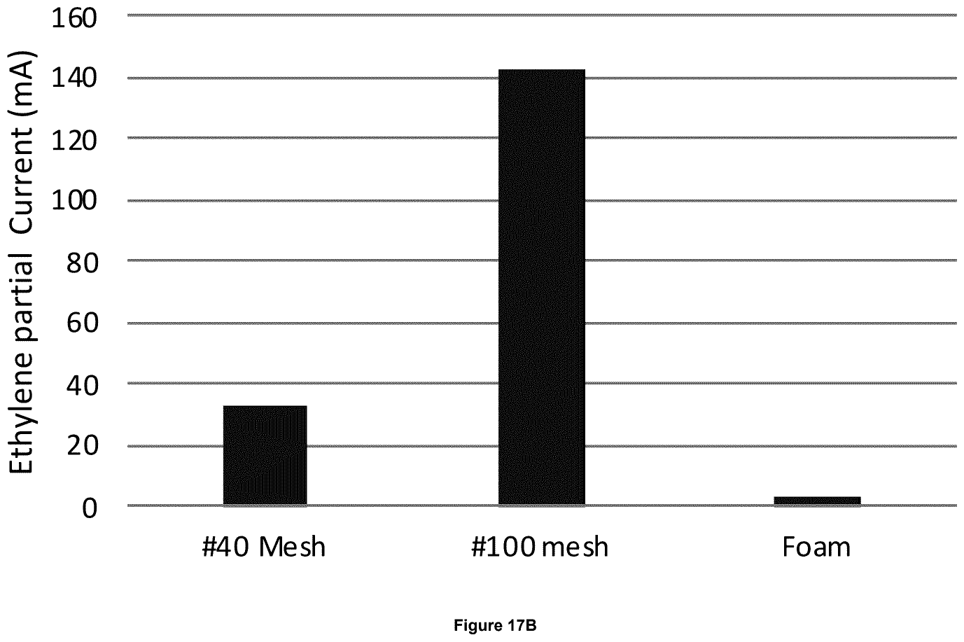

A comparison of a foam catalyst, a #100 mesh, and #40 mesh Cu catalyst is shown in FIGS. 17A and 17B. Foam was found to be the lease effective catalyst. It is believed that the pores in foam were too small for the product gas bubbles to readily escape. #100 mesh was found to peroform better than the #40 mesh. It is believed that with the #100 mesh, the pores were large enough to allow the gas bubbles to constantly escape and the #100 mesh had a larger exposed surface area as compared to the #40 mesh.

### Example 4: Reduction Efficiency

The reduction efficiency of the system was tested using a cell as illustrated in FIG. 5A simulating a reduction unit in accordance with the disclosure. The electrolyte was a combination of KCI and KHCO₃ in various volumetric ratios. KCI was observed to act as a supporting electrolyte and helped in achieving higher current densities while KHCO₃ facilitated CO₂ reduction. The reduction unit included a Cu mesh catalyst. Oscillating potential as described below was adjusted to determine the maximum efficiency of the reduction unit. The reduction unit was operated in flow-through mode with recirculation of the electrolyte and CO₂ was flowed into the unit. Referring to FIG. 5D, a high Faradaic efficiency of about 60% was obtained with a partial current of about 10 mA.

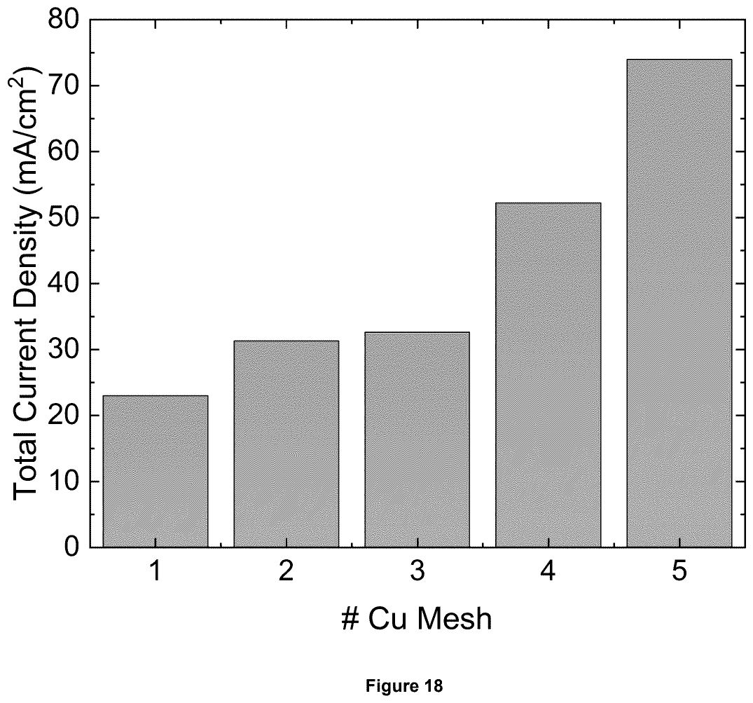

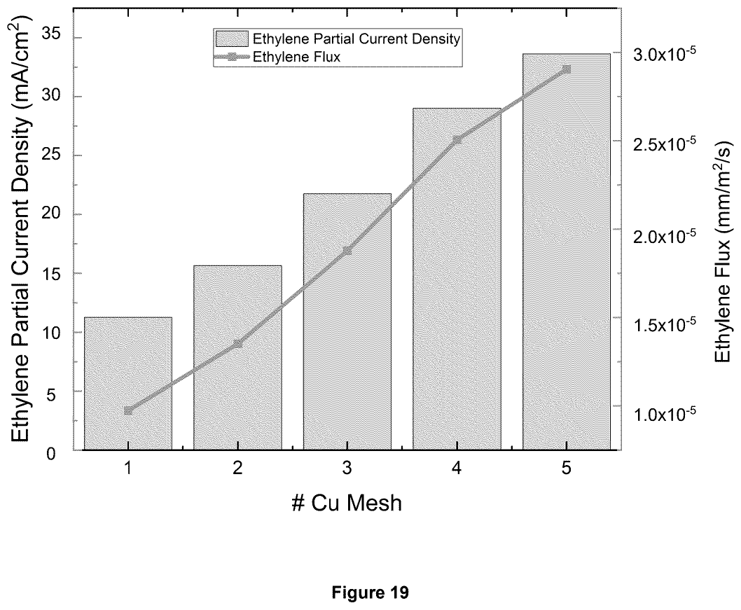

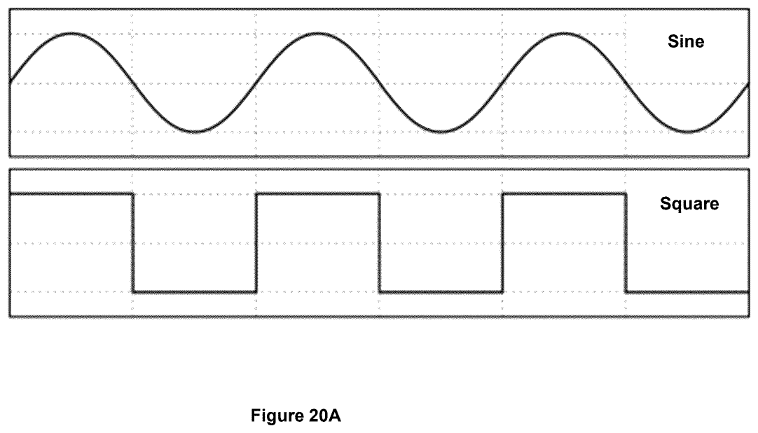

Referring to FIGS. 18 and 19, increase in current density was achieved by increasing the number of Cu mesh to provide a stack of Cu mesh as illustrated in reduction unit illustrated in FIG. 5B. The stack of Cu mesh are believed to behave like a porous electrode ensemble.

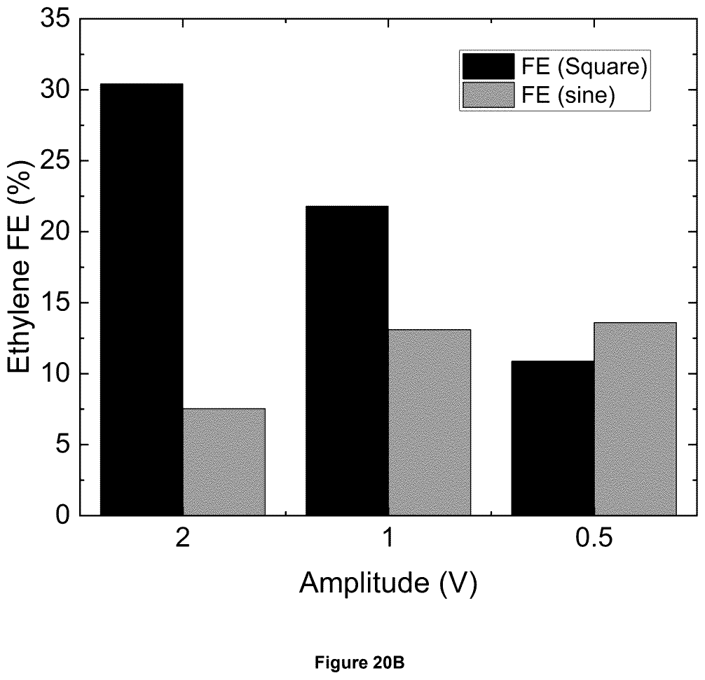

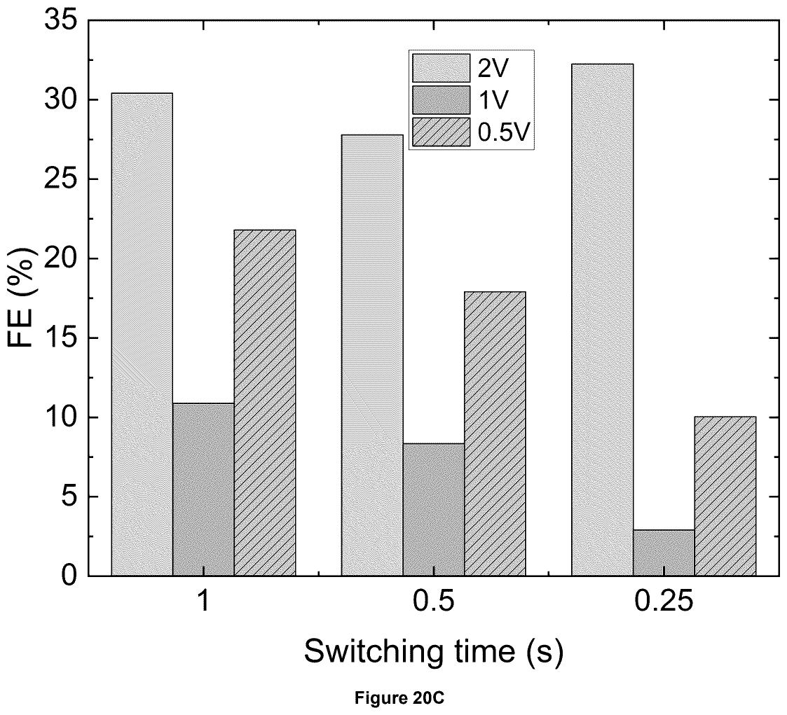

Sine and square wave oscillations (FIG. 20A) were tested for their effectiveness in improving selectivity. Oscillating potentials improve selectivity by reducing the depletion of CO₂ concentration at the surface and by taking advantage of Cu(I) reducibility to have control over C2+ selectivity. As illustrated in FIGS. 20A and 20B square wave oscillations were more effective.

### Prophetic Examples

### Prophetic Example 1

The performance curves for direct air capture (DAC) can be measured for state-of-the-art commercial anion exchange membranes (AEMs) (Excellion AEM, Fumatech FAA, Fujifilm, Novasep, Selemion AMV, Membrane International AMI, Tokuyama Neosepta, and Resintech AMB) of different properties, namely, water sorption, water permeability, ion-exchange capacity, ion conductivity, ion selectivity, CO₂ diffusivity, porosity, and membrane thickness.

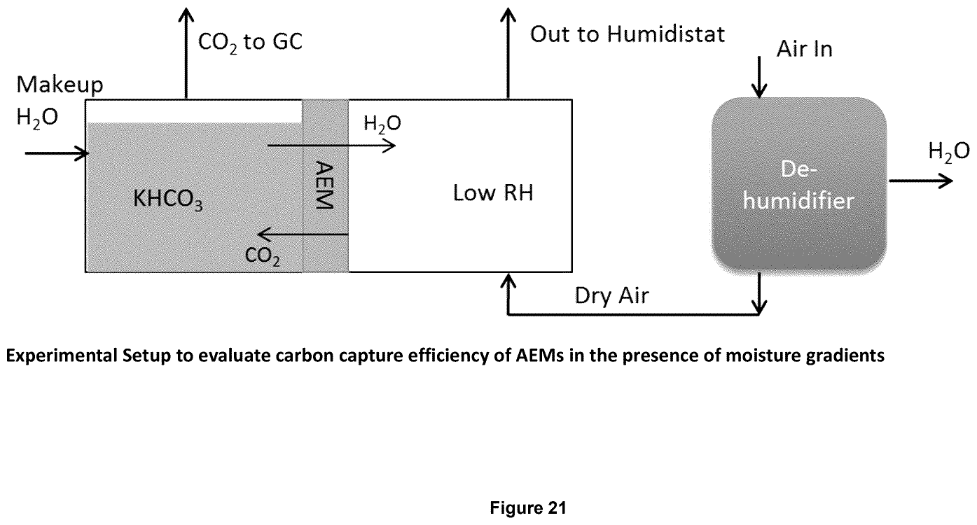

The CO₂ capture and separation efficiencies can be measured by direct quantification of water flux at the “dry” side and dissolved CO₂ concentration at the “wet” side using a suitable experimental setup, such as is shown in FIG. 21, which consists of a liquid chamber (left) and gas chamber (right) separated by AEM. The moisture-gradient in the AEM can be adjusted using a temperature-controlled dehumidifier that controls the RH and temperature of the gas chamber, if desired. The amount of CO₂ captured in the electrolyte can be measured by sweeping carrier gas through the electrolyte and quantified using gas chromatography. Alternatively, a calibration curve can be developed between dissolved CO₂ and pH, and a pH probe can be used to measure dissolved CO₂ concentration indirectly. The H₂O flux into the gas chamber can be measured using humidistat at the outlet. The make-up H₂O can keep the volume of electrolyte constant.

Next, the physical properties of the most promising AEMs can be measured experimentally with higher CO₂ separation and capture efficiencies under different operating conditions. H₂O and CO₂ absorption isotherms, ion-exchange capacity, the diffusion coefficient of HCO₃⁻, H₂O, and CO₂ can be measured using the previously developed diffusion cell setup. More specifically, the ion-exchange capacity of AEM can be measured using potentiometric Mohr titration, where the AEM can be activated, if desired, by first converting into Cl⁻ form and then immersing in 1M KNO₃ solution for 24 hrs, for example. The amount of Cl⁻ ions exchanged is determined by potentiometric titration with AgNO₃. The H₂O uptake/sorption isotherms can be determined using gravimetric analysis, where AEM can be first exchanged into HCO₃⁻ form followed by its equilibration in a humidity-controlled chamber for 24 hrs.

The conductivity of HCO₃⁻ form of AEM can be measured using two-probe in-plane impedance spectroscopy in a humidity-controlled chamber. To measure CO₂ sorption and diffusion coefficient, chronoamperometry can be performed in a diffusion cell with a suitable electrode on the downstream face of the AEM, that can register a reduction current after CO₂ is introduced into the upstream side and diffuses through the AEM. The transient current density data can be fitted to an analytical solution of Fick's second law of diffusion to obtain the CO₂ sorption and diffusion coefficient. The diffusion coefficients and isotherms can be measured for different RH and temperature.

In accordance with the principles herein, the AEMs with lower CO₂ diffusion coefficients can have higher CO₂ separation efficiency, higher HCO₃⁻ diffusion coefficient can support higher CO₂ capture efficiency, and lower H₂O permeability can reduce the energy required to dehumidify the air. The measured physical properties and performance metrics can be related to obtain property-performance relationships for DAC.

Next, COMSOL simulations can be performed using these measured physical properties to identify optimal operating conditions such as temperature, ionic strength of electrolyte, RH, air composition, air flow rate, electrolyte flow rate, CO₂ pressure, and H₂O flux to maximize the CO₂ separation and capture efficiencies. In other words, simulations can be used to identify optimal operating conditions, to elucidate the mechanism of CO₂ capture and transport, and to provide a diagnosis to improve CO₂ separation and capture efficiencies based on a particular system. For instance, such a diagnosis will identify whether higher back-diffusion of CO₂, higher H₂O flux, or lower HCO₃⁻ flux is limiting CO₂ capture and separation efficiencies. The COMSOL simulations can solve the mass, charge, energy, and momentum balance equations, where the transport of species can be described using Nernst-Planck equations, ionic equilibrium will be modeled using acid-base reactions, the partition of H₂O and CO₂ at the “dry” and “wet” interfaces can be defined using water sorption and CO₂ absorption isotherms, Donan equilibrium of ions can be applied at “wet” interface, and water-dependent CO₂ capture and release reactions can be implemented at the “dry” and “wet” interfaces.

The optimal operating conditions obtained from these simulations can guide the development of the CO₂ capture process systems, devices, units, and processes based on the air quality and temperature of different geographic locations so that the captured CO₂ rate matches with optimal CO₂ conversion rates. If the physical properties of promising AEMs are not favoring the target CO₂ capture rates, the H₂O sorption and permeability and CO₂ diffusion coefficient can be modified by thermal annealing to improve CO₂ capture performance. Thermal annealing is a facile route for tuning the morphology and crystallinity of polymer membranes and can be used to decrease gas and H₂O permeability. An increase in the crystallinity of the matrix can lead to a lower CO₂ solubility as gases are much more soluble in amorphous domains. Moreover, the larger crystallites can act as barriers and increase the tortuosity of the diffusion path for gas and H₂O molecules. The thermal annealing of the AEMs can be conducted in a suitable environment, such as a vacuum oven at specific temperatures (160-200° C.) for a suitable time, such as 24 hrs, followed by soaking in a suitable solution, such as 1M KOH electrolyte, before using in the diffusion cell. An intermediate temperature (˜160° C.) can favor a reduction in CO₂ permeability, as the exceedingly high temperatures can reduce the crystallinity of the AEM, which is required for lower CO₂ permeability. Additionally, the higher performance of CO₂ capture can be attained by increasing membrane interfacial area using either a hollow-fiber module or porous carbon substrates.

### Prophetic Example 2

In accordance with the principles herein, a full-scale electrochemical model can be configured in COMSOL to inform the design for the integrated CO₂ capture and conversion systems. The simulations can optimize the geometry and operating conditions of a prototype to achieve maximum CO₂ utilization rates with minimum power consumption. The COMSOL simulation for the electrochemical cell described by Singh et al. in “Effects of temperature and gas-liquid mass transfer on the operation of small electrochemical cells for the quantitative evaluation of CO₂ reduction electrocatalysts” can be used to calculate polarization losses, species distribution, and power efficiency in the fully integrated system. This COMSOL simulation can calculate voltage losses in the catalyst layers, electrolyte, and membrane separators, which depends on the: (i) kinetic over-potential of the electrocatalysts, (ii) conductivity and transference number of electrolyte and membrane, (iii) operating conditions such as CO₂ flowrate, partial pressure, and temperature, and (iv) physical dimensions of the components. The COMSOL simulations can solve the mass, charge, energy, and momentum balance equations, where the transport of species can be described using Nernst-Planck equations, ionic equilibrium in the electrolyte can be modeled using acid-base reactions, oxygen evolution reaction (OER) and CO₂ reduction reaction (CO₂RR) reactions can be described using Butler-Volmer expression, mixing pattern in the electrolyte can be described by Navier Stokes equation, and the CO₂ capture and separation can be modeled as described below. The total cell voltage can be expressed as a sum of the equilibrium potentials E⁰ and kinetic over-potentials η for the OER and CO₂RR, the solution losses Δϕₛₒₗᵤₜᵢₒₙ in the electrolyte and membrane, and the Nernstian losses Δϕ_{Nernstian} at the electrodes, and is given by

$$V ( J ) = {E}_{OER}^{0} - {E}_{C {O}_{2} R R}^{0} + {η}_{OER} ( J ) - {η}_{C {O}_{2} R R} ( J ) + Δ {ϕ}_{solution} ( J ) + Δ {ϕ}_{Nernestian} ( J )$$

The cell voltage and operating current density can be computed in COMSOL for the prototype configuration consisting of a suitable catalyst cathode, IrO₂ anode, 0.1-1M KOH/choline chloride hybrid electrolyte, 2-10 mm spacing between membrane and electrode, 0.01-0.1 mm thickness of boundary layer, and 5-100 sccm air flowrate at ambient conditions. The optimal geometry and operational conditions can be determined and can be used for the design and manufacturing of the integrated system.

Printing, assembly of an integrated system, and performance evaluation

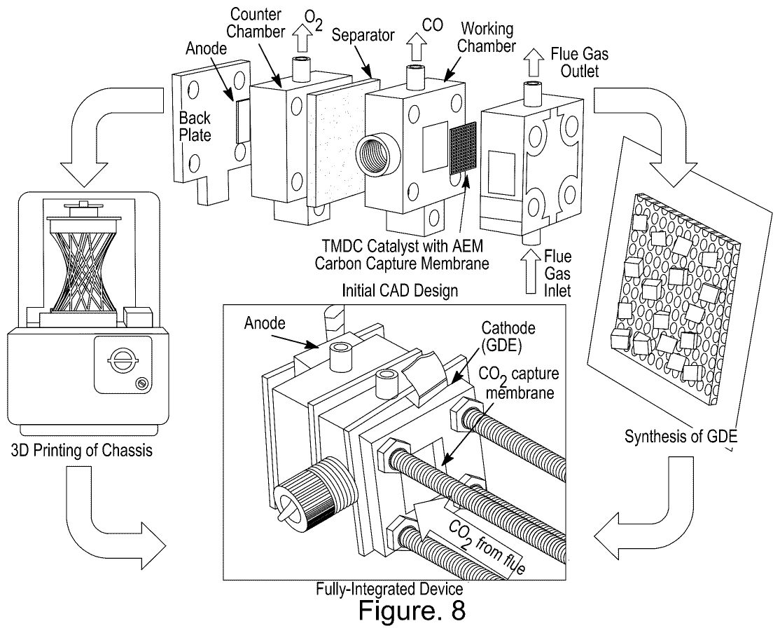

FIG. 8 (top) shows the initial CAD design of an exemplary electrochemical cell, where the CO₂ capture unit can be integrated with an anion exchange membrane serving as a catalyst-based gas diffusion electrode (GDE). The chassis can be designed in SolidWorks® and 3D printed using a Form 2 SLA 3D printer, if desired. The Form 2 printer can utilize Clear FLGPCL04 resin activated by 405 nm laser to print optically clear parts with 150 μm of lateral and 25 μm of axial resolutions. The resin can be chemically resistant to a wide range of solvents and pH ranges.

The post-washed 3D printed parts can be finished by removing supports and then curing for 20 minutes under a commercial ultraviolet lamp. The assembled device is shown in FIG. 5 (bottom). The GDE can be fabricated by spray coating of an ink comprised of catalyst, carbon particles (for enhanced electrical conductivity), and AEM ionomer (for carbon capture) on one side of porous carbon paper (substrate and current collector). The other side of carbon paper can be coated with only AEM ionomers, if desired.

The AEM-coated-side of carbon paper can capture CO₂, and the other side can convert the CO₂ to CO, or other output. The effect of the interaction between AEM ionomer and the catalyst on the activity and selectivity can also be evaluated using a flow cell setup. Alternatively, an electrospinning method can be used to fabricate the GDE electrode with the same configuration and ink composition to enhance its stability for long-term use. The relative concentration/area of AEM ionomer and a catalyst can be adjusted to match the rate of CO₂ capture with the conversion rate.

In systems of the disclosure improved conversion efficiencies can be obtained by utilizing a reduction catalyst can be separated from the CO₂ capture AEM using a zero-gap electrolyzer configuration. In this configuration, the AEM ionomer coated on the hollow-fiber module can be placed near the catalyst, such that CO₂ can be captured using the hollow-fiber module and transferred to the electrolyte in the zero-gap (<1 mm space), and can then be convert dissolved CO₂ to syngas.

Chronoamperometry experiments at different applied potentials can be performed on the fully automated integrated device to measure CO and H₂ production (using gas chromatography) over time to assess the effectiveness of CO₂ capture and conversion. The limiting factors such as degradation of AEM, aggregation of catalysts, or salt formation on AEM that determines the stability and lifetime of the device can be identified experimentally and diagnosed using the full-scale electrochemical model. Moreover, after optimizing the operational conditions, the long-term performance (from at least 100 to more than 500 hours) of the integrated system can be studied in a fully automated system.

The pH of the electrolyte can be varied in these chronoamperometric experiments to influence the selectivity of CO₂ reduction products to make it more selective towards other value-added products such as CH₄, HCOOH, C₂H₅OH and the like.

In accordance with the principles herein, counter-diffusion of H₂O and HCO₃⁻ in various anion exchange membranes (AEMs) can be customized to develop property-performance relationships for CO₂ capture from the air, reveal mechanistic insights into CO₂ transport and conversion in integrated systems, and examine the effect of ionomer-catalyst interactions on CO₂ conversion, develop standalone and modular devices and systems that can absorb CO₂ from the air, release O₂ and H₂O, and produce syngas or other products for industrial use.

The technical information set out herein may in some respects go beyond the disclosure of the invention, which is defined exclusively by the appended claims. The additional technical information is provided to place the actual invention in a broader technical context and to illustrate possible related technical developments. Such additional technical information which does not fall within the scope of the appended claims, is not part of the invention.

While particular embodiments of the present invention have been shown and described in detail, it will be obvious to those skilled in the art that changes and modifications may be made without departing from the invention in its broader aspects. Therefore, the aim is to cover all such changes and modifications as fall within the true spirit and scope of the invention. The matters set forth in the foregoing description and accompanying drawings are offered by way of illustration only and not as limitations. The actual scope of the invention is to be defined by the subsequent claims when viewed in their proper perspective based on the prior art.

1. An active CO₂ capture unit for capturing CO₂ from an input gas, comprising:
an inlet through which an input gas is introduced into the unit;
a non-aqueous region comprising a non-aqueous CO₂ binding organic liquid containing OH arranged to be in contact with the input gas to chemisorb CO₂ from the input gas and convert the chemisorbed CO₂ into HCO₃⁻ by reacting with OH⁻;
an aqueous region arranged downstream of the non-aqueous region, wherein at an aqueous region interface, the HCO₃⁻ interacts with H₂O and decomposes to CO₂ and CO₃²⁻;
an anion exchange membrane disposed between the non-aqueous region and the aqueous region to facilitate HCO₃⁻ diffusion and migration from the non-aqueous region to the aqueous region; and
a captured CO₂ outlet disposed downstream of the aqueous region.

2. The active CO₂ capture unit of claim 1, further comprising a cathode arranged upstream of the non-aqueous region, an anode arranged downstream of the aqueous region, and wherein the aqueous region comprises an aqueous electrolyte such that an electric field is adapted to be generated within the capture unit.

3. The active CO₂ capture unit of claim 1, wherein the non-aqueous CO₂ binding organic liquid comprises an ionic liquid.

4. The active CO₂ capture unit of claim 3, wherein the ionic liquid is imidazolium based or phosphonium based.

5. The active CO₂ capture unit of claim 1, wherein the non-aqueous CO₂ binding organic liquid comprises one or more ionic liquids selected from the group consisting of choline hydroxide, tetrabutylphosphonium methanesulfonate, 1-Butyl-3-methylimidazolium hexafluorophosphate.

6. (canceled)

7. The active CO₂ capture unit of claim 5, wherein the non-aqueous CO₂ binding organic liquid further comprises a non-aqueous polar organic solvent, and the non-aqueous polar organic solvent comprises one or more alcohols, organic amidine bases, and guanidine bases.

8. (canceled)

9. The active CO₂ capture unit of claim 1, wherein the non-aqueous region comprises an alkali metal hydroxide dissolved in the non-aqueous CO₂ binding organic liquid.

10. The active CO₂ capture unit of claim 1, wherein the aqueous region comprises one or both of an aqueous electrolyte and water.

11.-20. (canceled)

21. A system for active CO₂ capture and CO₂ reduction to a product gas, comprising:
the active CO₂ capture unit of claim 1;
a reduction unit arranged downstream of the active CO₂ capture unit such that the reduction unit receives captured CO₂ from the CO₂ capture outlet, the reduction unit comprising:
a reduction unit inlet for receiving the captured CO₂ from the CO₂ capture outlet, the reduction unit comprising a catalyst for reduction of the captured CO₂ arranged such that the captured CO₂ is flowed through the reduction unit into contact with the catalyst, wherein upon contact with the catalyst, the captured CO₂ is reduced to a product gas comprising one or more of C₂H₄, C₂H₅OH, CH₃COOH, CH₃OH, CH₄, C₃H₆, CO, and H₂;
a catalyst for oxidation of H₂O arranged downstream of the reduction unit and in fluid communication with the reduction unit to generate protons for CO₂ reduction and O₂ as a byproduct, wherein the catalyst for oxidation is an anode;
a separator arranged between the catalyst for reduction and the catalyst for oxidation; and
an energy source.

22. The system of claim 21, wherein the catalyst for reduction is a copper mesh.

23. (canceled)

24. The system of claim 21, wherein the catalyst comprises metal nanocrystals.

25. (canceled)

26. (canceled)

27. The system of claim 24, wherein the metal nanocrystals are grown on a mesh substrate.

28. The system of claim 21, wherein the catalyst for oxidation comprises one or more oxides of Ni, Fe—Ni, Pt-coated Ti, Ir, and Ru.

29. The system of claim 21, wherein the active CO₂ capture unit and the reduction unit is spaced a distance of about 5 mm to about 20 mm.

30. (canceled)

31. The system of claim 21, further comprising an outlet for the O₂ byproduct arranged spatially separated from an outlet for the product gas.

32. A method of capturing CO₂ using the active CO₂ capture unit of claim 1, comprising:
flowing the input gas into the inlet and into the non-aqueous region for chemisorbing CO₂ and conversion of the CO₂ to HCO₃⁻ by OH⁻ present in the non-aqueous region;
flowing the HCO₃⁻ across the anionic exchange membrane and into the aqueous region, wherein the flow of HCO₃⁻ is driven at least in part by a gradient of moisture across the anion exchange membrane, wherein upon flow in the HCO₃⁻ into the aqueous region, the HCO₃⁻ interacts with H₂O present in the aqueous region and decomposes to CO₂ and CO₃²⁻; and
flowing the CO₂ from the aqueous region to the captured CO₂ outlet.

33. The method of claim 32, further comprising flowing H₂O into the cathode for decomposition of the H₂O into H₂ and OH⁻, and flowing the OH⁻ into the non-aqueous region.

34. The method of claim 32, further comprising applying an electric field across the anion exchange membrane to increase a rate of transfer of HCO₃⁻ across the anion exchange membrane.

35. A method for capturing CO₂ and reducing CO₂ to a product gas comprising one or more of C₃H₆, C₂H₄, C₂H₅OH, CH₃COOH, CH₃OH, CH₄, CO, and H₂ using the system of claim 21, comprising:
flowing the input gas into the inlet and into the non-aqueous region for chemisorbing CO₂ and conversion of the CO₂ to HCO₃⁻ by OH⁻ present in the non-aqueous region;
flowing the HCO₃⁻ across the anionic exchange membrane and into the aqueous region, wherein the flow of HCO₃⁻ is driven at least in part by a gradient of moisture across the anionic exchange membrane, wherein upon flow in the HCO₃⁻ into the aqueous region, the HCO₃⁻ interacts with H₂O present in the aqueous region and decomposes to CO₂ and CO₃²⁻ thereby resulting in captured CO₂;
flowing the captured CO₂ from the aqueous region to the capture CO₂ outlet;
flowing the captured CO₂ from the capture CO₂ outlet into the reduction unit, wherein upon contact with the catalyst the captured CO₂ is reduced to the product gas comprising one or more of C₃H₆, C₂H₄, C₂H₅OH, CH₃COOH, CH₃OH, CH₄, CO, and H₂; and
flowing the product gas to a reduction unit outlet.

36. (canceled)

37. A system for capture and reduction of CO₂ from a dilute source, comprising:
a CO₂ capture unit, comprising:
an inlet through which an input gas is introduced into the unit,
a non-aqueous region comprising a non-aqueous CO₂ binding organic liquid containing OH⁻ arranged to be in contact with the input gas to chemisorb CO₂ from the input gas and convert the chemisorbed CO₂ into HCO₃⁻ by reacting with OH⁻;
an aqueous region arranged downstream of the non-aqueous region, wherein at an aqueous region interface, the HCO₃⁻ interacts with H₂O and decomposes to CO₂ and CO₃²⁻;
an anion exchange membrane disposed between the non-aqueous region and the aqueous region to facilitate HCO₃⁻ diffusion and migration from the non-aqueous region to the aqueous region,
a cathode arranged upstream of the capture unit and comprising an H₂O source inlet, an H₂ outlet, and a OH⁻ outlet in fluid communication with the non-aqueous region of the capture unit to flow OH⁻ to the non-aqueous region of the capture unit;
a reduction unit arranged immediate downstream of the aqueous region to receive a flow of the captured CO₂ from the capture unit, the reduction unit comprising a catalyst for reduction of the captured CO₂ and a product gas outlet such that the captured CO₂ is flowed through the reduction unit into contact with the catalyst, wherein upon contact with the catalyst the captured CO₂ is reduced to a product gas comprising one or more of C₂H₄, C₂H₅OH, CH₃COOH, CH₃OH, C₃H₆, CH₄, CO, and H₂ and the product gas if flowed out the product gas outlet;
an anode arranged downstream of the reduction unit and adapted to be a catalyst for oxidation of H₂O wherein oxidation of H₂O generates protons for the reduction unit and O₂ as a byproduct, wherein the anode is in fluid communication with the reduction unit to flow the protons to the reduction unit and an O₂ outlet spatially separate from the product gas outlet to remove O₂;
a separator arranged between the reduction unit and the anode; and
an energy source.

38.-59. (canceled)
